(19) United States
(12) Patent Application Publication
(10) Pub. No.: US 2026/0205949 A1
(43) Pub. Date: Jul. 16, 2026

(54) METHODS AND PROCEDURES ON LOW DENSITY OOK SEQUENCES FOR LOW POWER SYNCHRONIZATION AND WAKE UP SIGNALS

(71) Applicant: Huawei Technologies Co., Ltd., Shenzhen (CN)

(72) Inventors: Zhengxiang Ma, Summit, NJ (US); Hussain Elkotby, Belmont, MA (US); Ruikang Yang, Princeton, NJ (US)

(21) Appl. No.: 19/432,802

(22) Filed: Dec. 24, 2025

Related U.S. Application Data
(63) Continuation of application No. PCT/US2024/027621, filed on May 3, 2024.
(60) Provisional application No. 63/510,294, filed on Jun. 26, 2023.

(51) Int. Cl. H04W 52/02; H04L 1/00

(52) U.S. Cl. CPC H04W 52/0235; H04L 1/0063

(57) ABSTRACT

This application discusses unipolar and low density sequence usage. A method includes determining a sequence being a unipolar and low density sequence. The unipolar and low density sequence includes a number of ones, where the number of ones defines a density. The density of the sequence is low density by being less dense than a balanced density of 1 by at least two bits. The example method further includes receiving the unipolar and low density sequence based on at least one of a transmission periodicity or time resources, and a frequency, associated with a transmission configuration of at least a portion of a signal. The portion of the signal includes at least a low-power synchronization signal or a preamble portion of a low-power wake up signal.

### PRIORITY CLAIM AND CROSS-REFERENCE

This patent application is a continuation of International Application No. PCT/US2024/027621, filed on May 3, 2024 and entitled “METHODS AND PROCEDURES ON LOW DENSITY OOK SEQUENCES FOR LOW POWER SYNCHRONIZATION AND WAKE UP SIGNALS,” which claims priority to U.S. Provisional Application No. 63/510,294, filed on Jun. 26, 2023 and entitled “METHODS AND PROCEDURES ON LOW DENSITY OOK SEQUENCES FOR LOW POWER SYNCHRONIZATION AND WAKE UP SIGNALS,” applications of which are hereby incorporated by reference in their entireties.

### TECHNICAL FIELD

The present disclosure relates generally to managing the allocation of resources in a network, and in particular embodiments, to techniques and mechanisms for low density OOK sequence for low power synchronization and wake up signals.

### BACKGROUND

A study item on low-power wake-up signal (LP-WUS) and receiver (LP-WUR) for NR was approved in 3GPP RAN #94e and revised in RAN #97e. This study covers low-power receiver architectures, signal and protocol design, and evaluation methodology targeting metrics such as power saving gain, latency, coverage availability, coexistence with non-low-power-WUR UEs, and network resource overhead. On-off keying (OOK) is one of the main modulation schemes for LP-WUS signal design that was agreed for the study. In particular, waveform Option OOK-4, which was introduced in RAN1 #112 to support multiple OOK pulses (time domain segments) per NR OFDMA symbol, has received wide support. Further, a periodic low-power synchronization signal (LP-SS) is agreed to be beneficial for LP-WUS detection and decoding as well as for radio resource management (RRM) measurements. Embodiments include methods, devices, and non-transitory computer-readable storage media to use low density OOK sequences for LP-SS and LP-WUS design under waveform Option OOK-4 with distinct advantages over conventional approaches.

### SUMMARY

Technical advantages are generally achieved, by embodiments of this disclosure which describe low density OOK sequence for low power synchronization and wake up signals.

In accordance with a first aspect of the disclosure, a method is provided. The example method includes determining, by a wireless transmit/receive unit (WTRU), a sequence satisfying a criteria defining the sequence as a unipolar and low density sequence, where the sequence is based on a cell identifier (ID), where the sequence is associated with a density indicating a number of ones in the unipolar and low density sequence. The example method further includes receiving, by the WTRU, the unipolar and low density sequence based on a transmission periodicity, a frequency, and time resources associated with a transmission configuration of a low-power synchronization signal (LP-SS).

In some examples, the method includes determining, by a wireless transmit/receive unit (WTRU), a sequence, the sequence being a unipolar and low density sequence including a number of ones in the sequence. In the example method, the number of ones in the sequence defines a density of the sequence. Further in the example method, the density of the sequence is low density by being less dense than a balanced density of 1 by at least two bits. The example method further includes receiving, by the WTRU, the unipolar and low density sequence based on at least one of a transmission periodicity or time resources, and a frequency, associated with a transmission configuration of at least a portion of a signal. In the example method, the portion of the signal includes at least a low-power synchronization signal (LP-SS) or a preamble portion of a low-power wake up signal (LP-WUS).

In some examples, the method further includes where the unipolar and low density sequence is selected from a set of one or more pre-configured low density sequences.

In some examples, the method further includes where, at any offset other than 0, at least one balanced auto correlation values of the set of one or more pre-configured low density sequences is less than a fraction of at least one peak value of the at least one balanced auto correlation value.

In some examples, the method further includes where at least one balanced cross correlation of the set of one or more pre-configured low density sequences is less than a fraction of at least one peak value of at least one balanced auto correlation value of the set of one or more pre-configured low density sequences.

In some examples, the method further includes wherein the fraction is smaller or equal to 0.3.

In some examples, the method further includes where the transmission configuration of the LP-SS further includes any of an LP-SS structure, an LP-SS sequence length, a number of bits per OFDM symbol duration, or an LP-SS transmission pattern.

In some examples, the method further includes where the LP-SS structure is any of a structure of sequence only, a structure of sequence followed by a payload, or a structure of sequence followed by the payload and a cyclic redundancy check (CRC) sequence.

In some examples, the method further includes where each 0 bit in the unipolar and low density sequence corresponds to an OFF waveform or absence of transmission in a time domain, and where each 1 bit in the unipolar and low density sequence corresponds to an ON waveform or presence of transmission in the time domain.

In some examples, the method further includes where the LP-SS transmission pattern includes any of a LP-SS transmission window, a number of LP-SS transmissions per window, or a time-domain spacing between transmissions within the LP-SS transmission window.

In some examples, the method further includes where the transmission configuration of the LP-SS is transmitted to one or more UEs using any of a system information block (SIB) or a dedicated RRC message.

In some examples, the method further includes where the unipolar and low density sequence is based on a second part defined as

$$( {N}_{ID}^{( 2 )} = {N}_{ID}^{c e l l} mod 3 )$$

of the cell identifier defined as

$$( {N}_{ID}^{c e l l} = 3 {N}_{ID}^{( 1 )} + {N}_{ID}^{( 2 )} ) .$$

In some examples, the method further includes where the unipolar and low density sequence is based on a third part defined as

$$( {N}_{ID}^{( 3 )} = {N}_{ID}^{c e l l} mod {m}_{0} )$$

of the cell identifier defined as

$$( {N}_{ID}^{c e l l} ) ,$$

where m₀ includes a number of low density sequences supported by a system.

In some examples, the method further includes receiving, by the WTRU from a base station, index information indicating an index of the unipolar and low density sequence in the set of one or more pre-configured low density sequences.

In some examples, the method further includes where the unipolar and low density sequence includes a unipolar sequence of N₀ₛ 0 bits and N₁ₛ 1 bits, and wherein the density (η) of the unipolar and low density sequence is defined as

$$η = \frac{2 {N}_{1 s}}{{N}_{1 s} + {N}_{0 s}} .$$

In some examples, the method further includes where the unipolar and low density sequence includes a unipolar sequence of N₀ₛ 0 bits and N₁ₛ 1 bits, and wherein the unipolar and low density sequence has an equal number of 1 bits in a plurality of OFDM symbol durations within a transmission duration of the LP-SS.

In some examples, the method further includes where the density of the unipolar and low density sequence is less than or equal to any of 9/10, ¾, ½, or ¼.

In some examples, the method further includes receiving a number of sequences indicated based on a lower bound of the density.

In some examples, the method further includes where the unipolar and low density sequence is of low density when η is less than 1.

In some examples, the method further includes where the unipolar and low density sequence has an equal number of 1 bits in each OFDM symbol duration within an LP-SS transmission duration.

In some examples, the method further includes where an upper bound of the density is determined based on any of a sequence miss-detection rate, a sequence false alarm rate, or a number of sequences to be supported.

In some examples, the method further includes where the density of the unipolar and low density sequence is greater than or equal to any of ½ or ¼.

In some examples, the method further includes where a lower bound on the density is determined based on any of a sequence miss-detection rate, a sequence false alarm rate, or a number of sequences to be supported.

In some examples, the method further includes where a number of sequences to be supported is determined based on a target maximum cross-correlation between the sequences and a sequences density.

In some examples, the method further includes where the receiving the unipolar and low density sequence includes receiving a preamble and a signal body, the preamble including the unipolar and low density sequence.

In some examples, the method further includes where the receiving the unipolar and low density sequence includes receiving the LP-SS including the unipolar and low density sequence.

In accordance with another aspect, a device is provided. The device includes at least one processor and at least one non-transitory computer-readable storage medium having instructions stored thereon that, in execution with the at least one processor, causes the device to perform any one of the example methods described herein.

In accordance with another aspect, a computer program product is provided. The computer program product includes at least one non-transitory computer-readable storage medium having instructions stored thereon that, in execution with at least one processor, is configured for performing any one of the example methods described herein.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram for RF envelope detection in accordance with at least one aspect of the disclosure;

FIG. 2 illustrates a block diagrams of an architecture for IF envelope detection in accordance with at least one aspect of the disclosure;

FIG. 3 illustrates a block diagram of an architecture for BB envelope detection in accordance with at least one aspect of the disclosure;

FIG. 4 illustrates an example timeline showing a periodically transmitted LP-SS and potential relationship to LP-WUS transmissions with or without a preamble part in accordance with at least one aspect of the disclosure;

FIG. 5 illustrates an example circuit for the preamble detection based on envelope detection in accordance with at least one aspect of the disclosure;

FIG. 6 illustrates using sequences with approximately equal numbers of 1's and 0's, one embodiment uses low density sequences, in which there are fewer number of 1's than 0's in accordance with at least one aspect of the disclosure;

FIG. 7A and FIG. 7B illustrates example results from low density sequences in accordance with at least one aspect of the disclosure;

FIG. 8 illustrates an example chart depicting a required SNR versus normalized threshold for sequences with different density to achieve a target MDR in accordance with at least one aspect of the disclosure;

FIG. 9 illustrates simulation results for the preamble sequence miss detection rate versus SNR in accordance with at least one aspect of the disclosure;

FIG. 10 illustrates a chart depicting the performance of sequences with particular resolution ADCs in accordance with at least one aspect of the disclosure;

FIG. 11 illustrates a chart depicting the simulated frame error rate versus SNR for particular encoding schemes in accordance with at least one aspect of the disclosure;

FIG. 12 illustrates a flowchart depicting steps of an example method in accordance with at least one aspect of the disclosure;

FIG. 13 illustrates a flowchart depicting steps of an example method in accordance with at least one aspect of the disclosure;

FIG. 14 illustrates a flowchart depicting steps of an example method in accordance with at least one aspect of the disclosure;

FIG. 15 illustrates an example communications system in accordance with at least one aspect of the disclosure;

FIG. 16 illustrates an example communication system in accordance with at least one aspect of the disclosure;

FIGS. 17A and 17B illustrate example devices that may implement the methods and teachings in accordance with at least one aspect of the disclosure;

FIG. 18 illustrates an example base station in accordance with at least one aspect of the disclosure;

FIG. 19 illustrates a flowchart depicting steps of an example method in accordance with at least one aspect of the disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

The following descriptions include 3GPP RAN1 considerations on LP-WUS design in light of OOK modulation. Additionally, the following descriptions include an overview of existing OOK LP-WUR architectures and LP-WUS designs as discussed in 3GPP RAN1 standards meetings.

An aspect to be considered during the design of a LP-WUS is its conformance to OFDM transmitter architectures as may be utilized from base station vendors to reduce the complexity and cost of base station design and simplify integration into the OFDM system.

In one example scheme, to transmit LP-WUS within OFDM framework is to generate on-off keying (OOK) signal based on OFDM symbols (OFDM-OOK). LP-WUS is transmitted in the ON state and not transmitted in the OFF state for current OFDM symbol duration. Since this scheme fully conforms with the OFDM transmitter architecture, OFDM-OOK operates on the OFDM symbol boundaries, and there is not much need to change the base station hardware. In FR1 the sub-carrier spacing (SCS) can either be 15 kHz, 30 kHz, or 60 kHz, thus OFDM symbol duration can be long for the LP-WUS transmission on-off granularity, i.e., only a data rate of 14 kbps, 28 kbps, or 56 kbps can be supported. This scheme is referred to as waveform Option OOK-1 in RAN1 discussions.

In another example scheme for OOK signal generation while still conforming with the OFDM transmitter architecture, one may utilize discrete Fourier transform (DFT) as pre-processing before OFDM symbol generation, i.e., DFT-s-OFDM based OOK (DFT-S-OFDM-OOK) or (DFT-OOK). In this scheme, the OOK modulated signal is setup in the time domain before being transferred to frequency domain through DFT and mapped to desired tone locations, i.e., sub-carriers (SCs). Then the frequency domain LP-WUS signal, along with other legacy NR channels/signals go through an inverse Fourier transform (IFFT) to get a time domain baseband signal for further processing and transmission. This transmission scheme also allows full reuse of base station hardware thus low cost and complexity. One advantage of this scheme over OFDM-OOK is that it can divide the OFDM symbol duration into finer granularities enabling one OOK signal to occupy smaller duration than the OFDM symbol duration. In this regard, LP-WUS data rate could be increased and LP-WUS transmission time can be shortened which helps to reduce the chance of it being interfered with other high-power signals. This scheme is also referred to as waveform Option OOK-4 in the discussion of 3GPP standard's RAN1 meetings.

The following sections discuss the signal design and receiver architecture for envelope based OOK designs.

In the 3GPP RAN1 #112 meeting, three signal design options are considered based on OOK modulation. These are Option OOK-1 (Single-bit per OFDM symbol), Option OOK-2 (frequency domain Parallel M-bit OOK), and Option OOK-4 (Time-domain transformed M-bit OOK). For all options, the LP-WUS can be frequency multiplexed with other NR signals.

In Option OOK-1, a single OOK pulse/bit is transmitted per one OFDM symbol where all the subcarriers, e.g., N, allocated for LP-WUS are modulated to generate a non-zero power signal at the baseband of the LP-WUR for OOK-bit=1. Alternatively, all N subcarriers are allocated zero power (from LP-WUR's base band of view) for OOK-bit=0.

In Option OOK-2, M OOK pulses/bits are packed in a single OFDM symbol by frequency domain multiplexing where the N LP-WUS subcarriers are separated into M segments, possibly with guard-bands in-between and/or around the segments/LP-WUS, and each segment is modulated as in Option OOK-1, i.e., ≈N/M subcarriers are modulated to generate a non-zero power signal at the baseband of the LP-WUR for OOK-bit=1 and are allocated zero power (from LP-WUR's base band of view) for OOK-bit=0.

In Option OOK-4, M OOK pulses/bits are packed in a single OFDM symbol by time domain multiplexing followed by signal modification and time-to-frequency domain transformation. For example, the M-bits are converted into N′ samples by adding

$$( \frac{{N}^{′} - M}{M} - 1 )$$

zeros for each bit or by holding the bit value, i.e., 0 or 1, for

$$( \frac{{N}^{′} - M}{M} - 1 )$$

samples. The N′ samples are then optionally passed through a signal generation and modification block which can be used to shape the pulse of each bit. Afterwards, either DFT or a least square operation is performed to convert the time-domain signal into a frequency-domain signal of length N′. Then, in case N′ is selected to be >N subcarriers allocated for LP-WUS, a truncation step with an optional frequency-domain signal modification is performed. Finally, the N frequency-domain samples are allocated to the LP-WUS's N subcarriers for further OFDM modulation and transmission.

In some embodiments, OOK receiver architectures are divided into RF envelope detection and IF/BB envelope detection architectures.

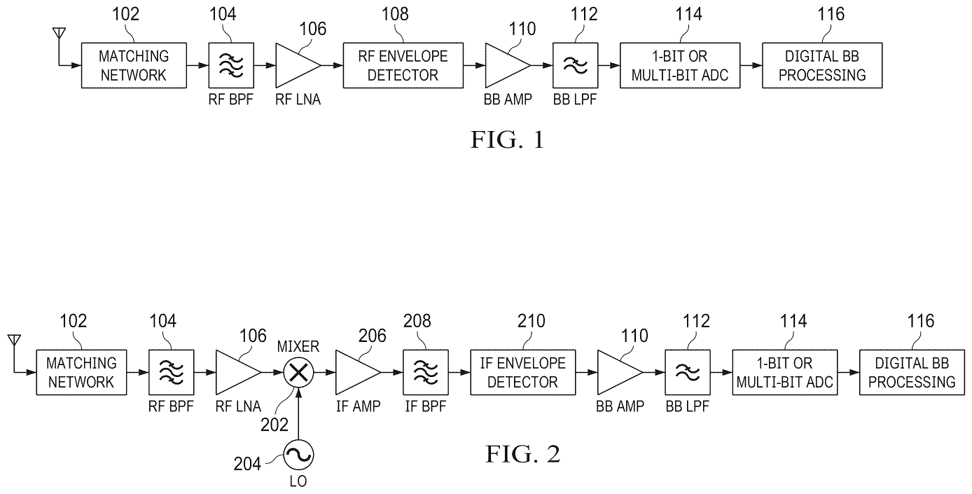

A basic block diagram for RF envelope detection is described in RAN1 #110bis-e and is shown in FIG. 1. The RF signal is converted directly into baseband using the RF envelope detector 108 and eliminating the need for local oscillators (LOs) or Phase-Locked Loops (PLLs). Signal digitization for digital baseband processing 116 can be performed using a 1-bit or multi-bit analog-to-digital converter (ADC) 114. The radio frequency (RF) Low Noise Amplifier (LNA) 106 and/or baseband (BB) Amplifier (AMP) 110 can be optionally considered, and/or BB low-pass filtering (BB LPF) 110 can optionally be considered. For this architecture, high-Q matching networks 102 and/or RF bandpass filtering (BPF) 104 are considered to suppress adjacent channel interference or interference from legacy new radio (NR) signal and/or other LP-WUS on adjacent subcarriers.

Basic block diagrams for IF and BB envelope detection are described in RAN1 #110bis-e and are shown in FIG. 2 and FIG. 3, respectively. In intermediate frequency (IF) envelope detection (FIG. 2), the RF signal is first converted to an IF signal using an LO 204 and an RF mixer 202, and then the IF signal is converted to a BB signal using the IF envelope detector 210. In this architecture, low power consumption is achieved by relaxing the accuracy and stability requirements of the LO 204. Signal digitization for digital baseband processing can be performed using a 1-bit or multi-bit ADC 114. The RF Low Noise Amplifier (LNA) 106 and/or IF amplifier (AMP) 206 and/or BB AMP 110 can be optionally considered. For this architecture, high-Q matching networks 102 and/or RF BPF 104 and/or IF BPF 208 are considered to suppress adjacent channel interference or interference from legacy NR signal and/or other LP-WUS on adjacent subcarriers. Further, an image rejection filter or an image rejection mixer is utilized. In another context, the RF signal in the BB envelope detection architecture (FIG. 3) is directly converted to BB signal using an LO 304 and an RF mixer 302. A high-Q matching networks 102 and/or an RF BPF 104 and/or a BB BPF or LPF 306 are considered to suppress adjacent channel interference or interference from legacy NR signal and/or other LP-WUS on adjacent subcarriers. Further, an image rejection filter may not be utilized.

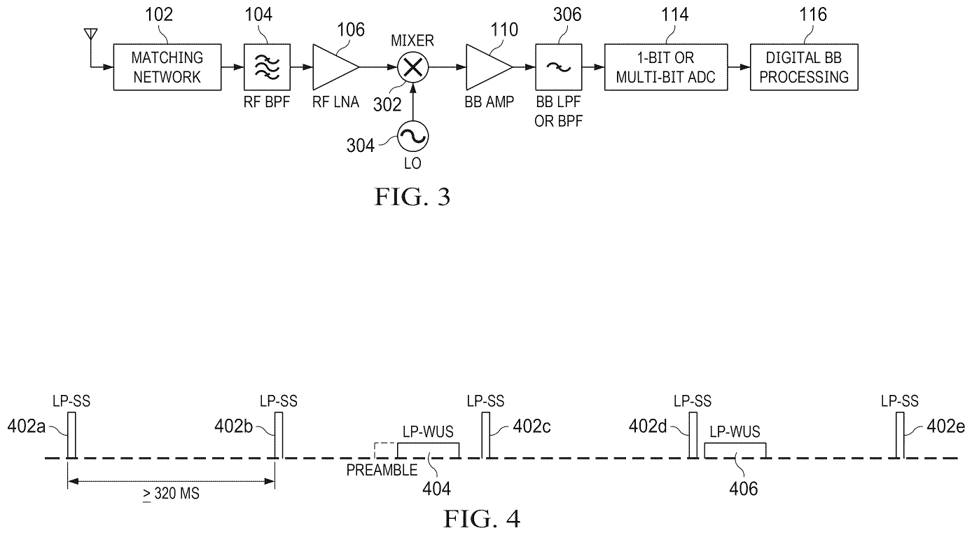

In RAN1 standards meetings, the need for and performance of OOK-based low power synchronization signal (LP-SS) are under discussion. A periodically transmitted LP-SS is intended to allow the LP-WUS receiver to acquire timing and frequency synchronization with the base stations. It can also be used for RRM measurements by LP-WURs at least for the serving cell. In addition, each LP-WUS message may also include or be preceded by a preamble part that may serve the same purpose, i.e., timing/frequency synchronization and/or RRM measurements. An exemplary timeline showing the periodically transmitted LP-SS 402a-402e and potential relationship to LP-WUS transmissions with a preamble part 404 or without a preamble part 406 is illustrated in FIG. 4 herein. Excellent coverage and low false alarm rate (FAR) are two design targets for signals utilized for synchronization and/or measurement purposes. Both LP-SS and LP-WUS preamble are expected to be new NR signals that can increase a network's resource overhead. Therefore, there is a desire for an OOK-based sequence design and LP-WUR detection procedure for the LP-SS and/or LP-WUS preamble to have excellent coverage, e.g., equal to or exceeds that of the LP-WUS, at low resource utilization and FAR.

Example embodiments based on low density OOK sequences are described, for example for LP-SS. Additionally and/or alternatively, example embodiments based on LP-WUS preamble design to achieve good coverage with low resource utilization and FAR are described.

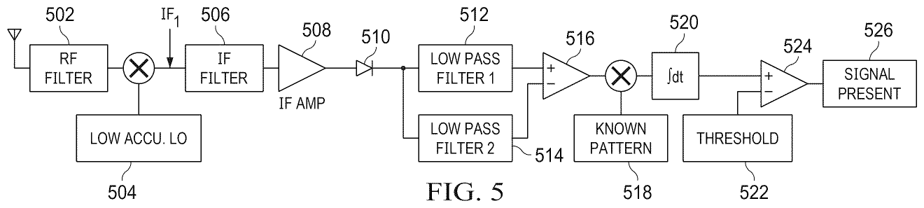

In some 802.11 standards, a specific random bit sequence of length 32 is chosen as a preamble to each WUS message. The sequence has an equal number of 1's, the number of 1's is given by N₁ₛ, and 0's, the number of 0's is given by N₀ₛ, i.e., N₁ₛ=N₀ₛ. The sequence is modulated onto 32 OFDM symbols using the scheme described as OOK-1 herein with time domain masking. In 802.11 standards, the subcarrier spacing (SCS) is 312.5 kHz, much higher than the 30 kHz SCS commonly supported in 5G NR and does not need to support frequency domain multiplexing with other signals. Directly importing this design would result in a much longer preamble in the time duration and much higher resource overhead. An advantageous approach may be to use waveform Option OOK-4 to support multiple bits per OFDM symbol. For example, modulating 8 bits, e.g., time domain segments, within each OFDM symbol can accommodate, e.g., a 32-length, preamble in 4 OFDM symbols. An example circuit for the preamble detection based on envelope detection is illustrated in FIG. 5 herein. In this example, an IF envelope detection is illustrated, and in some embodiments the IF envelope detection can be replaced by RF or BB envelope detection. The example circuit in FIG. 5 includes an RF filter 502, LO 504, IF filter 506, IF amplifier 508, and an envelope signal output 510. In some contexts, an OFDM based receiver with time domain sequence detection as defined in RAN1 #113 may also be used for the detection of the sequence but with tighter requirements on maximum frequency error. The envelope signal in the example is filtered by 2 low pass filters 512 and 514. Low pass filter 1 (512) has higher passband bandwidth to allow the OOK pulses through, while Low pass filter 2 (514) has lower passband bandwidth to obtain an average, e.g., a threshold, of the OOK pulses. The output of the two filters is subtracted and quantized using a comparator 516 to produce a bit stream. The bit stream is correlated with a known bit pattern 518, e.g., sequence, and the output of the correlator is compared 524 against a threshold 522 to determine if the desired LP-SS or preamble is present 526. The threshold 522 may be based on the known sequence length, e.g., N_{seq}=N₁ₛ+N₀ₛ, the sampling frequency, e.g., fₛ, and the effective data rate, e.g., Rₛ. The threshold can then be defined as a fraction α of the value N_{seq}fₛ/Rₛ where the fraction α can be selected to control the trade-off between sequence miss-detection and false alarm rates.

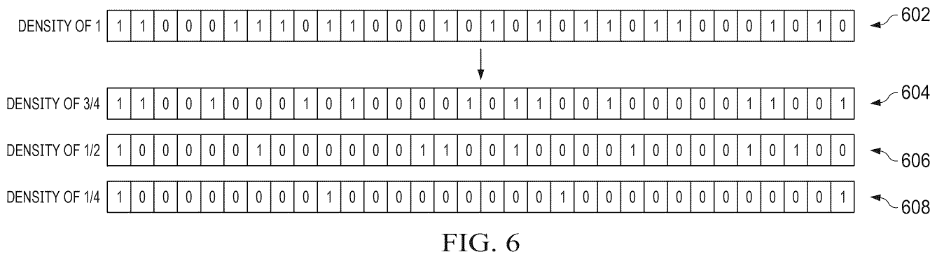

Instead of using sequences with approximately equal numbers of 1's and 0's, one embodiment uses low density sequences, in which there are fewer number of 1's than 0's. FIG. 6 below illustrates this concept. In the figure, a sequence 602 with the density of

$$η = \frac{2 {N}_{1 s}}{{N}_{s e q}} = 1$$

has sixteen 1's and sixteen 0's, a sequence 604 with the density of 7=% has twelve 1's and twenty 0's, a sequence 606 with the density of η=½ has eight 1's and twenty four 0's, and a sequence 608 with the density of η=¼ has four 1's and twenty eight 0's. In some examples, a low density sequence is defined by a density of a sequence being less dense than a balanced density of 1 (e.g., having an equal number of 0's and 1's) by at least two bits. In some examples a low density sequence is defined by a density of a sequence being less than a threshold density fraction, as discussed herein.

In addition, since it is desirable to keep the power of the OFDM symbols relatively constant to avoid the need for any power pooling across NR OFDM symbols and to ensure consistent signal levels for the OOK ON waveforms, it is identifiable that for every NR OFDM symbol, the number of 1's per symbol is the same. Power pooling refers to the possibility of sharing power across multiple OFDM symbols to maintain a certain average power but with a varying instantaneous power per OFDM symbol. By using low density sequences, more transmit power is concentrated in the fewer ON pulses, resulting in higher signal to noise ratio of the ON pulses. Moreover, during correlation, less noise is integrated into the correlator output, which reduces the opportunities for the correlator output to exceed the threshold due to noise signal alone. In other words, there is less chance for false alarm. At least these advantages, as well as additional and/or alternative advantages, are detailed, demonstrated, and verified through simulations in the disclosure.

One parameter in the detection of the preamble or LP-SS sequence is the detection threshold. Setting the threshold too high causes valid preamble or LP-SS signals to be missed, while setting it too low may allow random noise signals to be mistaken as preamble or LP-SS signals and cause false alarms. Therefore, the detection threshold should be set properly according to a desired FAR.

In one example analysis, let the sequence be modeled as containing N₁ₛ 1's. Each 1 pulse is a square pulse of N_{spb} independent samples. N_{spb} is determined by the bandwidth of the WUS signal. For example, if N_{WUS} subcarriers are allocated, then there should be at most N_{WUS} independent samples per OFDM symbol (excluding cyclic prefix). For AWGN channels, the noise signals in some contexts are complex Gaussian signals of zero mean and a certain standard deviation. In the following analysis, for the ease of analysis, it may be assumed that the envelope signal is normalized to have an average value of 1. In addition, an ideal matched filter is assumed. In other words, every group of N_{spb} samples of the envelope signal is averaged as the output of the matched filter.

In an example correlator, the known sequence pattern of 1's and 0's is first converted to a bipolar (antipodal) signal as ±1's, then multiplied with the input signal and integrated. When the density of the sequence is less than 1, its bipolar version has a negative correlator (DC) component. It is advantageous to remove this DC component by converting the 1's to +1 and 0's to

$$- \frac{{N}_{1 s}}{{N}_{0 s}}$$

for correlation calculations. Alternatively, the DC component can be removed by converting 1's to

$$\frac{{N}_{1 s}}{{N}_{0 s}}$$

and 0's to −1. Such a correlator may be referred to as a balanced correlator. First of all, it removes the correlator output's dependence on the input's DC component. Secondly, it de-emphasizes the OFF pulses which contains only noise, therefore, can offer a SNR advantage with low density sequences, as the following analysis shows.

In the case when the desired OOK sequence of density η is transmitted and received with noise, the received signal is ideally match-filtered, ideally sampled with infinite resolution, and perfectly aligned with the known sequence in the correlator. The transmitted ON pulse can be described as x(t)=Ae^{iφ(t)}, a complex modulated constant envelop signal. When it is received with noise, the envelope of the total signal is |x(t)+n(t)|²=A²+|n(t)|²+2A·Real(n(t)e^{iφ(t)}).

Match-filtering, or averaging over the bit period which consists of N_{spb} samples, produces:

$$\frac{1}{{N}_{s p b}} {\sum }_{t = 1}^{{N}_{s p b}} {\vert x ( t ) + n ( t ) \vert}^{2} = {A}^{2} + \frac{1}{{N}_{s p b}} {\sum }_{t = 1}^{{N}_{s p b}} {\vert n ( t ) \vert}^{2} + 2 A \cdot \frac{1}{{N}_{s p b}} {\sum }_{t = 1}^{{N}_{s p b}} Real ( n ( t ) {e}^{i ϕ ( t )} ) = {A}^{2} + \frac{1}{{N}_{s p b}} {\sum }_{t = 1}^{{N}_{s p b}} {\vert n ( t ) \vert}^{2} + 2 A \cdot \frac{1}{{N}_{s p b}} {\sum }_{t = 1}^{{N}_{s p b}} {n}_{r} ( t ) ,$$

where nᵣ(t) is the real part of n(t)

Its mean is μ_{ON}=A²+σ² and its standard deviation

$${σ}_{O N} = \sqrt{\frac{{σ}^{4} + 2 {A}^{2} {σ}^{2}}{{N}_{s p b}}} ,$$

where σ is the standard deviation of the noise.

When an OFF pulse is received, the averaged envelope of the total signal is

$$\frac{1}{{N}_{s p b}} {\sum }_{t = 1}^{{N}_{s p b}} {\vert n ( t ) \vert}^{2} ,$$

with a mean of μ_{OFF}=σ², and a standard deviation of

$${σ}_{OFF} = \frac{{σ}^{2}}{\sqrt{{N}_{spb}}} .$$

Assuming an ideal automatic gain control (AGC), the average of the envelope signal at the input of the correlator is set to 1, i.e.,

$$\frac{η}{2} {μ}_{ON} + ( 1 - \frac{η}{2} ) {μ}_{OFF} = \frac{η}{2} {A}^{2} + {σ}^{2} = 1$$

and letting the signal to noise ratio of the transmitted sequence

$${SNR}_{rf} = \frac{η {A}^{2}}{2 {σ}^{2}} ,$$

the following formula may be obtained:

$${σ}^{2} = \frac{1}{1 + {SNR}_{rf}} , {A}^{2} = \frac{2}{η} \frac{{SNR}_{rf}}{1 + {SNR}_{rf}} .$$

Therefore, the mean and standard deviation for a received ON pulse and OFF pulse are:

$${μ}_{ON} = \frac{1 + \frac{2}{η} {SNR}_{rf}}{1 + {SNR}_{rf}} and {σ}_{ON} = \frac{1}{1 + {SNR}_{rf}} \sqrt{\frac{1 + \frac{4}{η} {SNR}_{rf}}{{N}_{spb}}} , \\ {μ}_{OFF} = \frac{1}{1 + {SNR}_{rf}} and {σ}_{ON} = \frac{1}{1 + {SNR}_{rf}} \sqrt{\frac{1}{{N}_{spb}}} .$$

The correlator output is a sum of N₁ₛ ON pulses and N₀ₛ OFF pulses. Its average and standard deviation are:

$${μ}_{peak} = {N}_{1 s} {μ}_{ON} - {N}_{0 s} \frac{{N}_{1 s}}{{N}_{0 s}} {μ}_{OFF} = {N}_{1 s} ( {μ}_{ON} - {μ}_{OFF} ) = {N}_{1 s} {A}^{2} = \frac{{N}_{seq} {SNR}_{rf}}{1 + {SNR}_{rf}} , and$$

$${σ}_{peak} = \sqrt{{N}_{1 s} {σ}_{ON}^{2} + {{N}_{0 s} ( \frac{{N}_{1 s}}{{N}_{0 s}} {σ}_{OFF} )}^{2}} = \frac{1}{1 + {SNR}_{rf}} \sqrt{\frac{{N}_{seq}}{{N}_{spb}}} \sqrt{\frac{{N}_{1 s}}{{N}_{0 s}} + 2 {SNR}_{rf}} = \frac{1}{1 + {SNR}_{rf}} \sqrt{\frac{{N}_{seq}}{{N}_{spb}}} \sqrt{\frac{η}{2 - η} + 2 {SNR}_{rf}} .$$

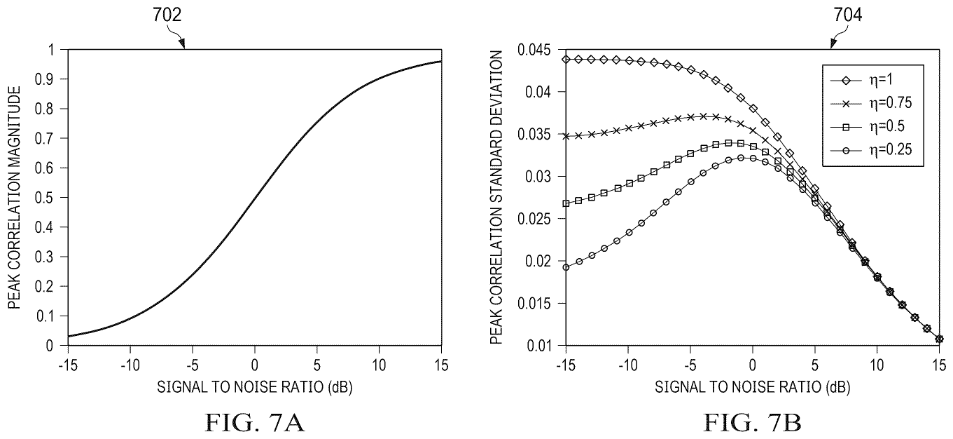

From these equations, it can be seen that the average value of the correlator peak output only depends on the (SNR) of the received signal, and does not depend on the density of the sequence, while the standard deviation does depend on the density of the sequence. FIG. 7A and FIG. 7B illustrate the dependence for a sequence length of N_{seq}=32 and N_{spb}=16 in a magnitude of output chart 702 and a standard deviation chart 704. From the figures, it can be observed that the standard deviation of the output decreases significantly with the density of the sequence, especially in low (SNR) regime. In addition, the relationship between the peak magnitude and SNR can be leveraged to provide a received signal strength indicator (RSSI) and/or reference signal received power (RSRP) measurement.

When a detection threshold is set as Th_{corr}, the miss detection rate (MDR) is the probability that the correlator peak output is below the threshold. It can be described by the well-known Gaussian distribution as:

$$MDR = \frac{1}{\sqrt{2 π}} {\int }_{- ∞}^{{Th}_{corr}} {e}^{- \frac{{( x - {μ}_{peak} )}^{2}}{2 {σ}_{peak}^{2}}} dx = \frac{1}{2} + \frac{1}{2} erf ( \frac{{Th}_{corr} - {μ}_{peak}}{\sqrt{2} {σ}_{peak}} ) ,$$

where erf( ) is the error function, defined as

$$erf ( x ) = \frac{2}{\sqrt{π}} {\int }_{0}^{x} {e}^{- {t}^{2}} dt .$$

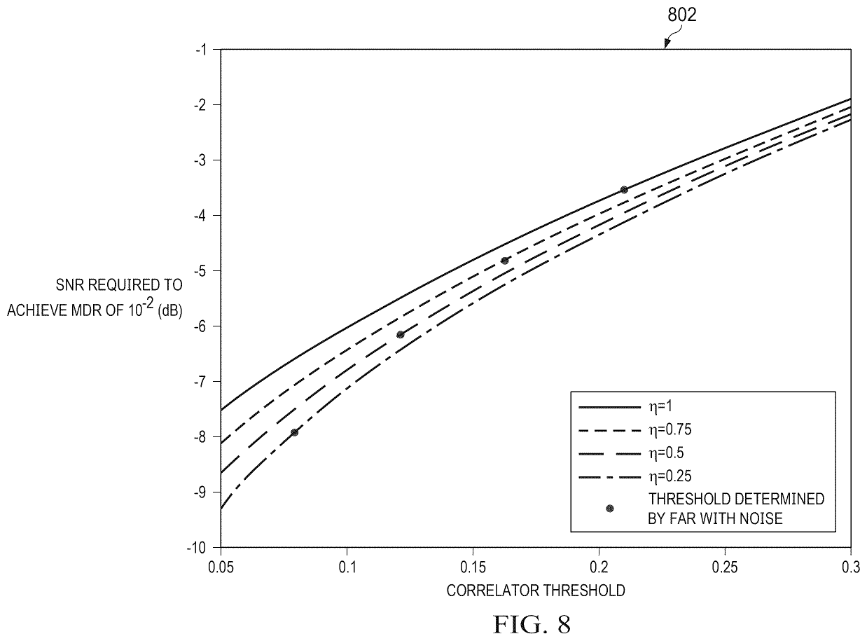

From this equation, the SNR required to achieve certain MDR for any threshold is calculable. FIG. 8 depicts a chart 802 that shows the required SNR versus normalized threshold for sequences with different density to achieve MDR of 10⁻². From the figure, it can be seen that as the detection threshold is increased, the SNR required to achieve the desired MDR also increases. Moreover, low density sequences can achieve the desired MDR at slightly lower SNR values. The advantage decreases as the detection threshold increases.

However, the detection threshold should be set such that when only noise is present, the correlator output does not exceed the threshold at a rate higher than the desired FAR. When the input signal is only complex Gaussian noise with an average power of 1, the output of the correlator can be approximately modeled as a Gaussian signal due to central limit theorem, and it has a mean of

$${μ}_{noise \_ only} = {N}_{1 s} {σ}^{2} - {N}_{0 s} \frac{{N}_{1 s}}{{N}_{0 s}} {σ}^{2} = 0$$

and a standard deviation of

$${σ}_{noise \_ only} = \sqrt{\frac{{N}_{seq}}{{N}_{spb}} \frac{η}{2 - η}} .$$

The probability that the correlator output exceeds a certain threshold Th_{corr} as

$$p = \frac{1}{\sqrt{2 π}} {\int }_{Th}^{∞} {e}^{- \frac{{( x - μ )}^{2}}{2 {σ}^{2}}} dx ,$$

by setting this probability to the desired FAR, the threshold is derivable as:

$${Th}_{corr} = {μ}_{{noise}_{only}} + \sqrt{2} {σ}_{{noise}_{only}} erfc inv ( 2 * FAR ) = \sqrt{\frac{2 {N}_{seq}}{{N}_{spb}} \frac{η}{2 - η}} erfc inv ( 2 * FAR )$$

where the erfcinv( ) function is the inverse complementary error function. As can be readily seen from the equation, the threshold decreases with the density of the sequence η. The thresholds determined by FAR with noise for sequences of various density are marked out in FIG. 8. The fact that with low density sequences the detection threshold is lower means that the desired sequence can be detected at lower SNR, which translates into better coverage for the signal.

For the case of 1-bit ADC as illustrated in FIG. 5, besides the detection threshold for the output of the correlator, the threshold for the first comparator also can be determined. More precisely, a scaling factor can be applied to the average of the envelope signal used as the threshold. In fact, the two parameters are not independent of each other, but rather inter-related. If the comparator threshold is lowered, it implies that a noise signal could trigger more 1's in the converted bit stream, therefore the detection threshold for the correlator can be increased to avoid more false alarms.

In this case, the maximum correlator output is only N₁ₛ instead of N_{seq}. A correlator detection threshold may be chosen as a percentage of the maximum output, i.e., Th_{corr}=αN₁ₛ. A reasonable choice for α is between 0.6~0.8. With noise only input, if the probability of obtaining 1 out of the comparator for each sample is p, the probability that out of N₁ₛ bits, k bits are 1 is described by a binomial distribution:

$${P}_{hit} ( k ) = ( \begin{matrix}{N}_{1 s} \\ k\end{matrix} ) {{p}^{k} ( 1 - p )}^{{N}_{1 s} - k} .$$

The probability that out of N₀ₛ bits, m bits are 1 is described by a binomial distribution:

$${P}_{miss} ( m ) = ( \begin{matrix}{N}_{0 s} \\ m\end{matrix} ) {{p}^{m} ( 1 - p )}^{{N}_{0 s} - m} .$$

The correlator output is simply

$$k - m \frac{{N}_{1 s}}{{N}_{0 s}} .$$

The probability that it exceeds the detection threshold is:

$${P}_{tot} = {Σ}_{k > {TH}_{corr}}^{{N}_{15}} {P}_{hit} ( k ) {Σ}_{m = 0}^{( k - {TH}_{corr} ) \frac{{N}_{0 s}}{{N}_{1 s}}} {P}_{miss} ( m ) = {Σ}_{k > {TH}_{corr}}^{{N}_{1 s}} ( \begin{matrix}{N}_{1 s} \\ k\end{matrix} ) {{p}^{k} ( 1 - p )}^{{N}_{1 s} - k} {Σ}_{m = 0}^{( k - {TH}_{corr} ) \frac{{N}_{0 s}}{{N}_{1 s}}} ( \begin{matrix}{N}_{0 s} \\ m\end{matrix} ) {{p}^{m} ( 1 - p )}^{{N}_{0 s} - m} .$$

Setting Pₜₒₜ to FAR, the equation may be numerically inverted to obtain the bit conversion, i.e., bit 1 detection, probability p.

Again using Gaussian approximation, given the input is the match-filtered envelope of a complex Gaussian signal with average power of 1, the probability that the signal exceeds the comparator threshold Th_{comp} is

$$p = \frac{1}{\sqrt{2 π}} {\int }_{T {h}_{c o m p}}^{∞} {e}^{- \frac{{( x - μ )}^{2}}{2 {σ}^{2}}} d x ,$$

with μ=1 and

$$σ = \sqrt{\frac{1}{{N}_{s p b}}} .$$

Therefore, the comparator threshold can be calculated based on the following equation:

$${TH}_{comp} = μ + erf cinv ( 2 p ) \sqrt{2} σ = 1 + erf cinv ( 2 p ) \sqrt{\frac{2}{{N}_{spb}}}$$

For higher resolution ADC of m bits, where m>1, the output of the ADC are integer values between 0 and 2^{m}−1. If the middle level of the ADC is set to Th_{comp}, each LSB of the ADC corresponds to C_{LSB}=2^{-m+1}Th_{comp}. The intervals for conversion can be defined as C(l)=[−∞, 0, 1, . . . , 2^{m}−1, ∞]·C_{LSB}, where l=0, 1, 2, . . . , 2^{m}. The probability for obtaining a value k between 0 and 2^{m}−1 with a noise only input is:

$$p ( k ) = \frac{1}{\sqrt{2 π}} {\int }_{C ( k )}^{C ( k + 1 )} {e}^{- \frac{{( x - μ )}^{2}}{2 {σ}^{2}}} dx = \frac{1}{2} ( erf ( \frac{C ( k + 1 ) - μ}{\sqrt{2} σ} ) - erf ( \frac{C ( k ) - μ}{\sqrt{2} σ} ) ) with μ = 1 and σ = \sqrt{\frac{1}{{N}_{spb}}} .$$

From this, the mean and standard deviation of the ADC samples can be calculated as:

$${μ}_{A D C} = {Σ}_{k = 0}^{{2}^{m} - 1} p ( k ) k and {σ}_{A D C} = \sqrt{{Σ}_{k = 0}^{{2}^{m} - 1} p ( k ) {k}^{2} - {μ}_{A D {C}^{2}}} .$$

Again, using central limit theorem, when N₁ₛ ADC samples are integrated together, in order for the correlator output not to exceed the detector threshold with probability higher than FAR, the detector threshold can be determined using the following equations:

$$T {h}_{c o r r} = erf cin v ( 2 * F A R ) \sqrt{\frac{2 {N}_{s e q} η}{2 - η}} {σ}_{A D C}$$

So far, the FAR discussed is per attempt, or per correlation calculation. In reality, every detection decision involves many correlation calculations. The relationship between the per-attempt FAR and per-decision FAR may be established with the following analysis.

Assuming the maximum clock error is δ=20 ppm, over LP-SS periodicity of τ=1 second, the maximum time offset is Δτ=δ·τ=20 μs. The correlation search window size can be set to 5Δτ=100 μs. With an OFDM symbol rate of 28 ksps and 8 uncoded OOK bits per symbol, the sampling rate for independent samples is 224 ksps. Therefore, in 100 μs, there are 23 independent correlation attempts. If the target FAR per detection decision is 0.1%, the target FAR per correlation calculation, i.e., attempt, is then about 4×10⁻⁵.

Simulations are carried out to demonstrate the advantages of using low density sequences for WUS design under additive white Gaussian noise (AWGN) channel conditions. The following are the assumptions in the simulation: 1) Ideal automatic gain control (AGC): the envelope signals are normalized to an average value of 1; 2) Ideal square pulses are used to represent the OOK sequences; 3) Ideal matched filter is used to filter the output of the envelope detector.

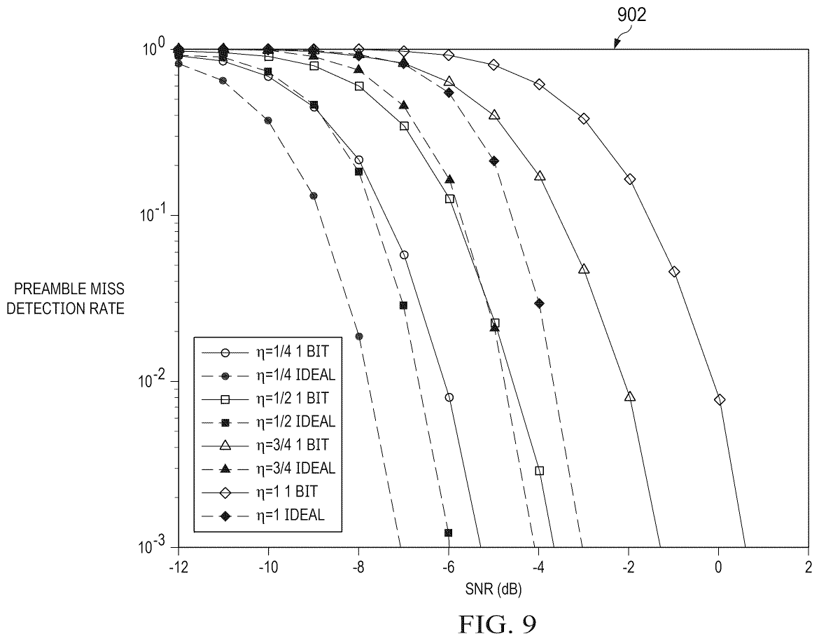

Some of the settings in the simulation are: 1) the length of the sequences is 32 bits, occupying 4 OFDM symbols; 2) 16 independent samples per bit, corresponding to 128 independent samples per OFDM symbol, equivalent to 128 subcarriers allocated; 3) The per-attempt FAR is set to 10⁻⁶; 4) 4 types of sequences are compared: conventional (equal number of 1's and 0's), ¾ density, ½ density and ¼ density sequences. The simulation results for the preamble sequence miss detection rate versus SNR are shown in the chart 902 of FIG. 9 below for the 4 types of sequences. For each sequence, two results are shown, one with ideal detection, the other with a 1-bit ADC.

From the figure, improvements of 1.5 dB, 3 dB, 4 dB over η=1 sequence for ¾ density, ½ density and ¼ density sequences, respectively, are observed at a miss detection rate of 10⁻² with ideal detection. With 1-bit ADC, the performance improvement is greater, at 2 dB, 5 dB and 6 dB, respectively. It is worth noting that the simulation results of the SNR values required to achieve the desired MDR agree quite well with the marked-out values in FIG. 8.

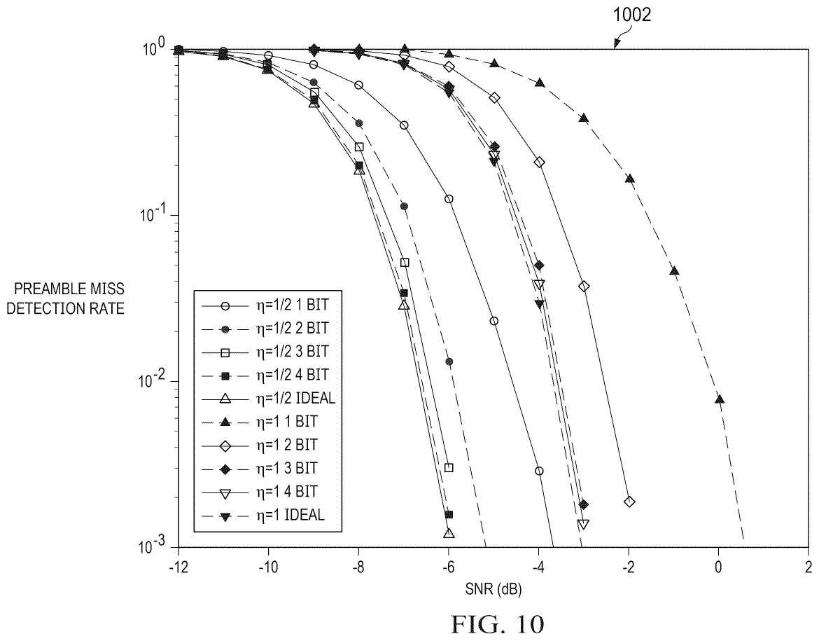

FIG. 10 shows a chart 1002 depicting the performance for 2 sequences with higher resolution ADCs. It can be observed that with a 3-bit ADC, the performance is already very close to the infinite precision ADC.

Since the low density sequences are used for timing and frequency synchronization, cell identification, and other possible usage, consideration should be given to their auto and cross correlation properties.

First, the auto and cross correlation is defined in the context of balanced correlation discussed earlier. Let X₀(k) and X₁(k) be two unipolar sequences for k=1, 2, . . . N_{seq}. Unipolar is defined such that the sequences consist of 1's and 0's. Let x₀(k) be the balanced version of X₀(k), in which, e.g., 1's are converted to +1, and 0's are converted to

$$- \frac{{N}_{1 s}}{{N}_{0 s}} .$$

The auto-correlation of sequence X₀(k) at offset m is defined as

$$Δ ( m ) = {Σ}_{k = 1}^{{N}_{s e q}} {X}_{0} ( k - m ) {X}_{0}^{′} ( k ) .$$

Its maximum value at offset of 0 is N₁ₛ, the number of 1's in the sequence. The cross-correlation between the 2 sequences at offset m is defined as

$$Γ ( m ) = {Σ}_{k = 1}^{{N}_{s e q}} {X}_{1} ( k - m ) {X}_{0}^{′} ( k ) .$$

For accurate timing acquisition, it is important that the main correlation peak (offset of 0) be identified rather than a correlation peak at an offset other than 0. This would place a requirement on the auto-correlation of the sequence at offset other than 0. The lower the value, the better. In some embodiments, the auto-correlation of the sequence at offset other than 0 should be no greater than 0.3N₁ₛ.

When different sequences are being transmitted simultaneously, in some contexts for example, each base station is transmitting a different sequence as LP-SS, it is important for the receiver to be able to differentiate them. This would place a requirement on the maximum value of the cross-correlation between the 2 sequences. A reasonable requirement is that it should be no greater than 0.3N₁ₛ.

In addition, when this is implemented using Option OOK4, the cyclic prefixes should be factored in. Gaps should be inserted in the balanced sequence to match the cyclic prefixes in the transmitted sequence. This does modify the auto and cross correlation result.

An example of sequences that satisfy those requirements are shown in the following Table 1 including example length 32 sequences of density ½ with auto and cross correlation properties meeting a sufficiency threshold.

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| 0 | 1 | 0 | 1 | 0 | 1 | 1 | 0 | 0 | 1 | 0 | 0 | 1 | 1 | 0 | 1 |
| 1 | 0 | 0 | 0 | 0 | 0 | 0 | 0 | 1 | 0 | 0 | 0 | 0 | 0 | 0 | 0 |
| 2 | 0 | 0 | 0 | 1 | 0 | 0 | 0 | 0 | 0 | 0 | 0 | 0 | 0 | 0 | 0 |
| 3 | 0 | 0 | 0 | 0 | 0 | 0 | 0 | 0 | 0 | 0 | 0 | 1 | 0 | 0 | 0 |
| 4 | 0 | 0 | 1 | 0 | 0 | 0 | 1 | 0 | 1 | 0 | 0 | 0 | 0 | 0 | 1 |
| 5 | 0 | 1 | 0 | 0 | 1 | 0 | 0 | 1 | 0 | 1 | 1 | 0 | 0 | 1 | 0 |
| 6 | 1 | 1 | 0 | 1 | 0 | 1 | 1 | 0 | 0 | 1 | 1 | 0 | 1 | 1 | 0 |
| 7 | 0 | 0 | 0 | 0 | 0 | 0 | 0 | 0 | 0 | 0 | 0 | 0 | 0 | 0 | 0 |
| 8 | 0 | 1 | 0 | 1 | 0 | 1 | 1 | 0 | 0 | 1 | 1 | 0 | 0 | 1 | 0 |
| 9 | 0 | 0 | 0 | 1 | 0 | 0 | 1 | 0 | 0 | 1 | 0 | 0 | 0 | 1 | 0 |
| 10 | 0 | 1 | 0 | 0 | 0 | 1 | 0 | 0 | 0 | 0 | 0 | 0 | 0 | 0 | 0 |
| 11 | 0 | 0 | 1 | 0 | 0 | 0 | 0 | 0 | 0 | 0 | 1 | 0 | 0 | 0 | 0 |
| 12 | 0 | 0 | 0 | 0 | 0 | 0 | 0 | 0 | 1 | 0 | 0 | 0 | 0 | 0 | 0 |
| 13 | 1 | 0 | 0 | 0 | 1 | 0 | 0 | 1 | 0 | 0 | 0 | 1 | 1 | 0 | 1 |
| 14 | 1 | 0 | 1 | 0 | 1 | 0 | 0 | 1 | 1 | 0 | 0 | 1 | 1 | 0 | 1 |
| 15 | 0 | 0 | 0 | 0 | 0 | 0 | 0 | 0 | 0 | 0 | 0 | 0 | 0 | 0 | 0 |
| 16 | 0 | 1 | 0 | 0 | 1 | 0 | 0 | 1 | 1 | 0 | 1 | 1 | 0 | 0 | 1 |
| 17 | 1 | 0 | 1 | 0 | 1 | 0 | 0 | 0 | 0 | 1 | 1 | 0 | 1 | 1 | 0 |
| 18 | 0 | 0 | 0 | 0 | 0 | 0 | 1 | 0 | 0 | 0 | 0 | 0 | 0 | 0 | 1 |
| 19 | 0 | 0 | 0 | 1 | 0 | 1 | 0 | 0 | 0 | 0 | 0 | 0 | 0 | 0 | 0 |
| 20 | 0 | 0 | 0 | 0 | 0 | 0 | 0 | 0 | 0 | 0 | 0 | 0 | 0 | 0 | 0 |
| 21 | 0 | 0 | 0 | 0 | 0 | 0 | 0 | 0 | 0 | 0 | 0 | 0 | 0 | 0 | 0 |
| 22 | 1 | 1 | 1 | 1 | 0 | 1 | 1 | 0 | 1 | 1 | 0 | 1 | 1 | 1 | 0 |
| 23 | 0 | 0 | 0 | 0 | 0 | 0 | 0 | 1 | 0 | 0 | 0 | 0 | 0 | 0 | 0 |
| 24 | 0 | 0 | 0 | 1 | 1 | 1 | 1 | 0 | 0 | 0 | 0 | 0 | 0 | 0 | 0 |
| 25 | 0 | 0 | 0 | 0 | 0 | 0 | 0 | 0 | 0 | 0 | 1 | 1 | 1 | 0 | 0 |
| 26 | 0 | 0 | 0 | 1 | 0 | 0 | 0 | 0 | 0 | 1 | 0 | 1 | 0 | 0 | 0 |
| 27 | 1 | 0 | 1 | 0 | 0 | 1 | 0 | 0 | 1 | 0 | 0 | 0 | 0 | 0 | 1 |
| 28 | 0 | 1 | 0 | 0 | 0 | 0 | 1 | 1 | 1 | 0 | 0 | 0 | 0 | 1 | 0 |
| 29 | 1 | 0 | 0 | 0 | 0 | 0 | 0 | 1 | 0 | 0 | 0 | 0 | 0 | 0 | 0 |
| 30 | 0 | 1 | 0 | 0 | 0 | 0 | 0 | 0 | 0 | 0 | 0 | 0 | 1 | 0 | 1 |
| 31 | 0 | 0 | 1 | 0 | 1 | 0 | 0 | 0 | 0 | 1 | 1 | 0 | 0 | 1 | 0 |

The same low density sequence concept can be extended to the encoding of payload data in WUS messages. In an example considering waveform Option OOK-4 with four coded bits per OFDM symbol, a Manchester code with ½ code rate can be used to encode each bit of information into two coded OOK-4 bits. The information bit to OOK pulse/coded bit mapping is shown in the following Table 2 below including different combinations of two consecutive information bits. Subsequently, for this coding scheme, each OFDM symbol carries 2 ON pulses, i.e., two coded bits with ON waveform. On the other hand, using low density encoding with density, e.g., η=½, only a single ON pulse, i.e., coded bit with ON waveform, is used per OFDM symbol, for the considered example, to represent 2 bits of information. The information bit to OOK pulse/coded bit mapping is also shown in the following Table 2 for this low density coding scheme. Note that other densities, e.g., η≤¾, or η≤ 9/10, or the like, may be considered for information bit encoding using the low density encoding scheme. In some examples, a density for a low density sequence is based on the sequence length.

In some examples, a low density sequence embodies a “significantly low density sequence.” A significantly low density sequence that is significantly less dense than a balanced density of 1 (e.g., less dense than an equal number of 1's and 0's), such that the lesser density of the significantly low density sequence provides a desired improvement over use of sequences having a balanced density in one or more metrics (e.g., SNR, FAR, and/or the like). In this regard, in some such examples, a significantly low density sequence provides at least a threshold improvement in one or more of such metrics by having a density that does not approximate the metric values resulting from use of a balanced sequence (e.g., having an equal number of o's and 1's). It will be appreciated that a significantly low density sequence in some examples is based on a sequence length, and/or any of the other parameters discussed herein with respect to improving any metric/parameter value in transmission.

| | |
|---|---|
| Manchester encoding | Low density encoding |

| Information bits | OOK bits | Information bits | OOK bits |
|---|---|---|---|
| 00 | 1010 | 00 | 1000 |
| 01 | 1001 | 01 | 0100 |
| 10 | 0110 | 10 | 0010 |
| 11 | 0101 | 11 | 0001 |

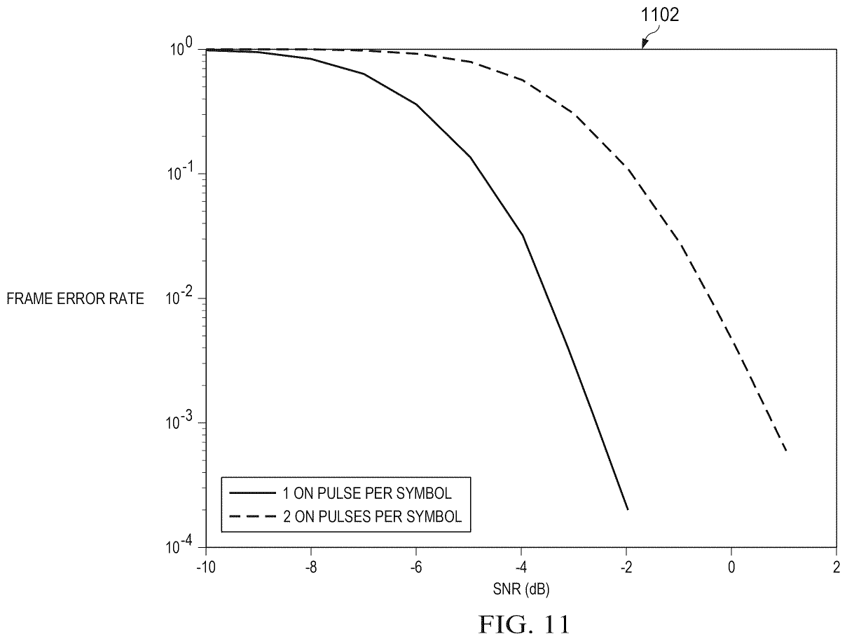

FIG. 11 shows a chart 1102 depicting the simulated frame error rate versus SNR for these two encoding schemes. The following assumptions are made in the simulation: 1) ideal square pulses; 2) ideal matched filtering; 3) ideal AGC; 4) ideal timing and sampling; 5) AWGN channel; 6) Ideal decoding. By ideal decoding, it is meant that for Manchester decoding, a comparator in analog domain is used to compare 2 consecutive OOK bits to obtain the information bits, while decoding the low density encoded OOK bits, the location of the maximum of the 4 pulses within a symbol is used.

In the simulation, each WUS message consists of 10 OFDM symbols, each coded OOK bit consists of 16 independent samples (e.g., equivalent to 128 subcarriers). From the figure it can be readily observed that ½ density encoding improves the performance at 10⁻² frame error rate by 3 dB.

In an embodiment, a UE may be configured or pre-configured to monitor one or more low density sequence(s) before triggering the decoding of a low-power wake-up signal (LP-WUS). The one or more sequence(s) may be used to indicate different LP-WUS decoding configurations, e.g., different data rates, lengths, bandwidths, or structures. The low density sequence in this scenario acts as a preamble that precedes the LP-WUS or that is part of the LP-WUS. The low density sequence(s) may also be configured to carry any other control information for the decoding of the LP-WUS.

In one example, the UE may be preconfigured, e.g., through specification, or configured, e.g., through RRC signaling, to monitor a low density sequence to trigger the decoding of LP-WUS. The UE then decodes a LP-WUS based on fixed or signaled configuration upon the detection of the low density sequence. The LP-WUS decoding configuration may include any of allocated time and frequency resources, data rate, structure, and coding scheme and rate.

In another example, the UE may be preconfigured, e.g., through specification, or configured, e.g., through RRC signaling, to monitor one of two low density sequences before LP-WUS decoding where each sequence indicates a set/sub-set of LP-WUS decoding configuration. The UE may be configured to monitor LP-WUS based on signaled baseline/default configuration including allocated time and frequency resources, structure, and coding scheme and rate whereas the data rate is determined based on the detected low density sequence preceding the LP-WUS. In a first example, the UE may be configured, or pre-configured, to monitor a first sequence of density, e.g., η=½, of length, e.g., 32 bits, and of, e.g., 8 bits, per OFDM symbol. The UE then determines a first configuration, e.g., a first data rate corresponding to 8 coded bits per OFDM symbol, based on the detection of the first sequence. Subsequently, the UE utilizes the determined first data rate to decode a LP-WUS received after the detection of the first sequence. In a second example, the UE may be configured, or pre-configured, to monitor a second sequence of density, e.g., η=½, of length, e.g., 32 bits, of a cyclic shift, e.g., 16, and of, e.g., 8 bits, per OFDM symbol. The UE then determines a second configuration, e.g., a second data rate corresponding to 4 coded bits per OFDM symbol, based on the detection of the second sequence. Subsequently, the UE utilizes the determined second data rate to decode a LP-WUS received after the detection of the second sequence.

Note that the fixed, baseline, or default LP-WUS monitoring configuration may be signaled using common, i.e., SIB, or dedicated RRC messages. Further, other low density sequence(s) configuration may be considered, e.g., η≤¾ or η≤½ or η≤¼. Note also that a lower limit on the density may be imposed by both the requirement on an approximately fixed number of 1 bits per OFDM symbols and the sequence detection performance. In one example, when the number of bits per OFDM symbol is determined to be, e.g., 4 bits, there can be a minimum number of only one 1 bit out of each four bits, subsequently, the minimum density is η≤½. In another example, when the number of bits per OFDM symbol is determined to be, e.g., 8 bits, there can be a minimum number of only one 1 bit out of each eight bits, subsequently, the minimum density is η≤¼.

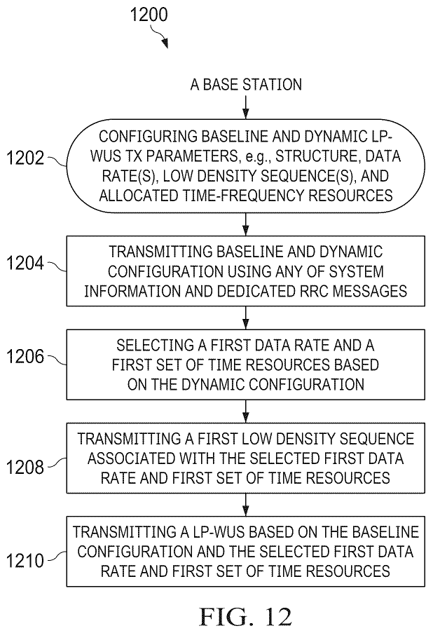

In an exemplary embodiment method 1200 illustrated in FIG. 12, a base station (BS) determines, in a step 1202, a LP-WUS transmission configuration including any of:
LP-WUS structure(s), e.g., payload size(s) and frame check sequence (FCS), wherein FCS may be based on cyclic redundancy check (CRC).
LP-WUS transmission data rate(s), e.g., low and/or high data rate. The low data rate may correspond to a data rate of any of 14 kbps, 24 kbps, and 56 kbps whereas the high data rate may correspond to a data rate of any of 56 kbps and 112 kbps.
LP-WUS coding scheme(s) and rate(s), e.g., Manchester encoding with ½ code rate or the like.
Selected preamble(s), e.g., low density sequence(s), either as preceding LP-WUS or as part of LP-WUS. In a technical realization, the selected preamble(s) may be indicated using indices to a set of preambles in a table.
Set(s) of frequency and time resources for preamble and/or LP-WUS transmission.

In a step 1204, the BS transmits preamble and/or LP-WUS transmission configuration using, e.g., system information or dedicated RRC messages. The configuration may be split into baseline/default configuration and dynamic configuration. In one example, the baseline configuration can include LP-WUS structure, LP-WUS coding scheme and rate, and frequency resources. The dynamic configuration can include the LP-WUS transmission data rate and time resources which are triggered based on a mapping to one or more low density sequence(s) that precedes the transmission of LP-WUS, e.g., as a preamble. In a step 1206, the BS selects a first data rate and/or a first set of time resources, which in some embodiments is based on the determined preamble and/or LP-WUS transmission configuration (e.g., a dynamic configuration). In a step 1208, the BS transmits a first low density sequence based on a first data rate and a first set of time resources. In a step 1210, the BS transmits a LP-WUS using the baseline configuration and the first data rate and the first set of time resources.

In an alternative to the step 1204, the configuration is fixed and includes a single set of all the parameters utilized for the decoding of a LP-WUS, e.g., a single and fixed LP-WUS structure, data rate, coding scheme and rate, low density sequence as preamble, and allocated frequency and time resources. Subsequently, the BS transmits a low density sequence followed by a LP-WUS based on the fixed configuration.

In some contexts, an upper bound on the density of the sequences, e.g., η≤¾ or η≤½ or η≤¼ may be selected to target a certain miss-detection and false alarm rate, whereas, a lower limit on the density may be imposed by the requirement on any of an approximately fixed number of 1 bits per OFDM symbols, number of supported sequences with good cross correlation properties, and the sequence(s) detection performance. The lower limit on density may be selected as any of η≥½ and η≥¼.

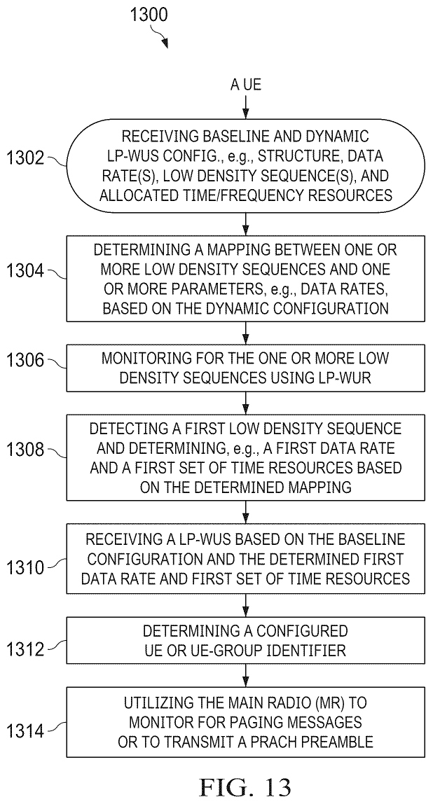

In another exemplary embodiment process 1300 illustrated in FIG. 13, a UE receives, in a step 1302, LP-WUS transmission configuration including any of:
LP-WUS structure(s), e.g., payload size(s) and frame check sequence (FCS), wherein FCS may be based on cyclic redundancy check (CRC).
LP-WUS transmission data rate(s), e.g., low and/or high data rate. The low data rate may correspond to a data rate of any of 14 kbps, 24 kbps, and 56 kbps whereas the high data rate may correspond to a data rate of any of 56 kbps and 112 kbps.
LP-WUS coding scheme(s) and rate(s), e.g., Manchester encoding with ½ code rate or the like.
Selected preamble, e.g., low density sequence(s), either as preceding LP-WUS or as part of LP-WUS. In a technical realization, the selected preamble(s) may be indicated using indices to a set of preambles in a table.
Set(s) of frequency and time resources for preamble and/or LP-WUS transmission.

The configuration may be received using any of system information, e.g., in a SIB, and dedicated RRC messages via a main radio (MR). In a step 1304, the UE determines a baseline configuration and a dynamic configuration. In one example, the baseline configuration can include LP-WUS structure, LP-WUS coding scheme and rate, and frequency resources. The dynamic configuration can include the LP-WUS transmission data rate and time resources which are triggered in some embodiments based on a mapping to one or more low density sequence(s) that precedes the transmission of LP-WUS, e.g., as a preamble.

In a step 1306, the UE monitors for and/or receives, via a low-power wake-up receiver (LP-WUR), a first low density sequence based on baseline configuration. In a step 1308, the UE determines a first data rate and a first set of time resources based on the received dynamic configuration. In a step 1310, the UE, via a LP-WUR, receives and decodes a LP-WUS using the baseline configuration and the first data rate and the first set of time resources. In a step 1312, the UE determines any of a UE identifier and a UE-group identifier matching a configured identifier. In a step 1314, the UE monitors for paging messages using the MR. Alternatively, the UE transmits a physical random access channel (PRACH) preamble using the MR.

In an alternative to the step 1302 and/or 1304, the configuration is fixed and includes a single set of all the parameters utilized for the proper decoding of a LP-WUS, e.g., a single and fixed LP-WUS structure, data rate, coding scheme and rate, low density sequence as preamble, and allocated frequency and time resources. Subsequently, the UE monitors for and/or receives a low density sequence followed by a LP-WUS based on the fixed configuration using the LP-WUR.

In another embodiment, a UE may be configured to monitor a low density sequence which can be received according to a known time domain configuration, e.g., periodicity, monitoring window, and a pattern within the monitoring window. The time domain configuration can be provided to the UE in any of common RRC messages, i.e., SIB(s), or dedicated RRC messages, e.g., RRC reconfiguration. The low density sequence with known periodicity can be used for any of timing synchronization, frequency synchronization, and RRM measurements. In this context, the low density sequence(s) may be identified as low-power synchronization signal (LP-SS) or as part of the LP-SS, e.g., a low density sequence followed by a payload carrying additional information, e.g., a part of the cell identifier or a synchronization assistance information element such as a part of a counter value.

In one example context, the unipolar low density sequence d_{LDS} used for synchronization and/or measurements by a LP-WUR may be determined based on, e.g., the serving cell ID, or more particularly the second part of the serving cell ID where

$${N}_{ID}^{cell} = 3 {N}_{ID}^{( 1 )} + {N}_{ID}^{( 2 )}$$

is the cell ID, and

$${N}_{ID}^{( 1 )} and {N}_{ID}^{( 2 )}$$

are the first and second parts of the cell ID, respectively. In a first example, the low density sequence d_{LDS}(n), n∈{0, 1, 2, . . . , 31} can be determined as:

$${d}_{L D S} ( n ) = x ( n ) , 0 \leq n < 32$$

$$x ( i + 8 ) = ( x ( i ) + x ( i + {M}_{1} ) ) mod 2$$

$$[ x ( 7 ) x ( 6 ) x ( 5 ) x ( 4 ) x ( 3 ) x ( 2 ) x ( 1 ) x ( 0 ) ] = [ 00000101 ]$$

where M₁∈{2, 4, 6} is selected based on the value of

$${N}_{ID}^{( 2 )}$$

∈{0, 1, 2}.

In a second example, the low density sequence d_{LDS}(n), n∈{0, 1, 2, . . . , 31} can be determined as:

$${d}_{L D S} ( n ) = x ( m ) , 0 \leq n , m < 32$$

$$m = ( n + 11 {N}_{ID}^{( 2 )} ) mod 32$$

$$x ( i + 8 ) = ( x ( i ) + x ( ( i + {M}_{2} ) mod 8 ) ) mod 2$$

$$[ x ( 7 ) x ( 6 ) x ( 5 ) x ( 4 ) x ( 3 ) x ( 2 ) x ( 1 ) x ( 0 ) ] = [ 00000101 ]$$

where any of the values M₂∈{1,5} may be selected.

In a third example, the low density sequence d_{LDS}(n), n∈{0, 1, 2, . . . , 31} can be determined as:

$${d}_{LDS} ( n ) = x ( n ) , 0 \leq n < 32$$

$$m = ( n + 11 {N}_{ID}^{( N )} ) mod 32$$

$$x ( i + 8 ) = ( x ( i ) + x ( i + {M}_{3} ) ) mod 2$$

$$[ x ( 7 ) x ( 6 ) x ( 5 ) x ( 4 ) x ( 3 ) x ( 2 ) x ( 1 ) x ( 0 ) ] = [ 00000011 ]$$

where M₃ may be selected to be 1.

In a fourth example, the low density sequence d_{LDS}(n), n∈{0, 1, 2, . . . , 31} can be determined as:

$${d}_{LDS} ( n ) = x ( m ) , 0 \leq n , m < 32$$

$$m = ( n + 11 {N}_{ID}^{( 2 )} ) mod 32$$

$$x ( i + 8 ) = ( x ( i + {M}_{4} ) + x ( ( i + {M}_{5} ) mod 8 ) ) mod 2$$

$$[ x ( 7 ) x ( 6 ) x ( 5 ) x ( 4 ) x ( 3 ) x ( 2 ) x ( 1 ) x ( 0 ) ] = [ 01000001 ]$$

where M₄ and M₅ may be selected to be 2 and 6, respectively.

For the four examples above, other initializing seeds may be considered for the first 8 bits in the sequence as well as the offsets (M₁, M₂, M₃, M₄, M₅), additionally the length of the initializing seed may be different, e.g., 4 or 16 bits. The selection of the initializing seed(s), the length of the initializing seed(s), and the offsets are such that the final sequence has a density η<1 and the number of 1 bits per OFDM symbol are approximately the same. Note that other upper bound on the density of the sequences, e.g., η≤¾ or η≤½ or η≤¼ may be selected to target a certain miss-detection and false alarm rate, whereas, a lower limit on the density may be imposed by the requirement on any of an approximately fixed number of 1 bits per OFDM symbols, number of supported sequences with good cross correlation properties, and the sequence(s) detection performance. In some example embodiments, the lower limit on density may be selected as any of η≥½ and η≥¼.

In another example context, the low density sequence d_{LDS}(n), n∈{0, 1, 2, . . . , 31} can be selected from one of the entries in Table 1 above, where the entry index is determined based on, e.g., the value of

$${N}_{ID}^{( 2 )} ∈ \{ 0 , 1 , 2 \} ,$$

of the serving cell ID. A subset of the entries in Table 1 may be selected and indices may be updated accordingly. Further, in some example contexts, the length of the sequence may be trimmed to 16 instead of 32 and a first or a second half of the sequence(s) may be considered. In some example contexts, the sequences in Table 1 are selected to satisfy a density of η=½, however, other tables can be generated through exhaustive search to include sequences of different lengths and densities as any of η≤¾, η≤½, and η≤¼. The low density sequences in the table may also be constrained to have a lower limit on density as any of η≥½ and η≥¼. The lower and upper limit on density will result in a trade-off between any of a detection performance, a false alarm rate, an auto correlation properties, cross correlation properties, and a number of entries/sequences in the table.

In another example context, the unipolar low density sequence d_{LDS} used for synchronization and/or measurements by a LP-WUR may be determined based on a part of the serving cell ID, e.g.,

$${N}_{ID}^{( 3 )} = {N}_{ID}^{c e l l} mod {m}_{0} ,$$

where m₀ is an integer, e.g., m₀=5, and

$${N}_{ID}^{( 3 )} ∈ \{ 0 , 1 , … , {m}_{0} - 1 \} .$$

The low density sequence d_{LDS}(n), n∈{0, 1, 2, . . . , 31} may then be determined as:

$${d}_{LDS} ( n ) = x ( m ) , 0 \leq n , m < 32$$

$$m = ( n + {A}_{0} {N}_{ID}^{( 3 )} ) mod 32$$

$$x ( i + {L}_{0} ) = ( x ( i + {L}_{1} ) + x ( ( i + {L}_{2} ) mod {L}_{0} ) ) mod 2$$

$${\sum }_{i = 0}^{{L}_{0} - 1} x ( i ) \cdot {2}^{i} = {c}_{i n i t}$$

In a first example, the value of A₀ is set as

$$⌈ \frac{32}{{m}_{0}} ⌉$$

where ┌⋅┐ is the ceil operation, L₀ is the length of the initializing sequence, e.g., L₀=8, and the combination of L₁ and L₂ is selected to result in a low density sequence for the initializing seed, cᵢₙᵢₜ. For example, L₁=2 and L₂=6 for cᵢₙᵢₜ=65. In a second example, the value of A₀ is set to 0, L₀ is the length of the initializing sequence, e.g., L₀=8, and the combination of L₁ and L₂ is selected based on the value of

$${N}_{ID}^{( 3 )}$$

from a set of combinations that result in a low density sequence for the initializing seed, cᵢₙᵢₜ. In a third example, the value of A₀ is set to 0, L₀ is the length of the initializing sequence, e.g., L₀=8, and the combination of L₁ and L₂ is selected to result in a low density sequence for a set of initializing seeds. In the third example, the initializing seed cᵢₙᵢₜ is selected from the set of initializing seeds based on the value of

$${N}_{ID}^{( 3 )} .$$

For all the above examples, the length of the low density sequence may be selected to be 16 instead of 32 and the length of the initializing sequence may be selected to be 4 instead of 8. Further, the low density sequence d_{LDS}(n), n∈{0, 1, 2, . . . , 31} for the above technical realization may be selected from one of the entries in Table 1, where the entry index is determined based on, e.g., the value of

$${N}_{ID}^{( 3 )} ∈ \{ 0 , 1 , … , {m}_{0} - 1 \} ,$$

of the serving cell ID. In some example contexts, a subset of the entries in, e.g., Table 1 or any other table generated for low density sequences as discussed above, may be selected and indices may be updated accordingly. Further, in some contexts, the length of the sequence may be trimmed to 16 instead of 32 and a first or a second half of the sequence(s) may be considered. In some examples, a set of low density sequences (e.g., a set of one or more pre-configured low density sequences) consists entirely and exclusively of low density sequences, for example where the set consists of a plurality of low density sequences. In some examples, a set of low density sequences includes a plurality of low density sequences and at least one non-low density sequence.

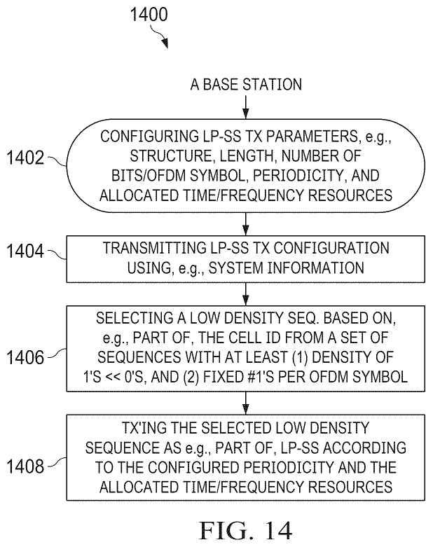

In an exemplary embodiment process 1400 illustrated in FIG. 14, a BS determines, in a step 1402, LP-SS transmission configuration including any of:
LP-SS structure(s), e.g., sequence only.
LP-SS sequence length and number of bits, e.g., time domain segments, per OFDM symbol.
LP-SS transmission periodicity and pattern, e.g., transmission window, number of LP-SS transmissions per window, and time-domain spacing between transmissions.
Set(s) of frequency and time resources for LP-SS transmission.

In a step 1404, the BS transmits LP-SS transmission configuration using, e.g., system information or dedicated RRC messages. In a step 1406, the BS determines and/or selects a low density sequence based on the cell ID. The low density sequence may be determined from a formula as described above or from a set of sequences in a table which satisfy a certain criteria such as low density of 1's compared to 0's, fixed number of 1's in every OFDM symbol used for transmission of LP-SS, and cross-correlation properties, e.g., maximum cross-correlation≤0.5×N₁ₛ. In a step 1408, the BS transmits the determined (e.g., selected) low density sequence based on the determined periodicity, pattern, and determined frequency and time resources.

In some example contexts, the LP-SS structure may also consist of a sequence followed by a payload or a sequence followed by a payload and a FCS, e.g., CRC.

In another exemplary embodiment, a BS determines, in a first step, LP-WUS transmission configuration including any of:
LP-WUS structure(s), e.g., sequence only.
LP-WUS sequence length and number of bits, e.g., time domain segments, per OFDM symbol.
LP-WUS transmission occasions configuration, e.g., duty cycle and number of occasions per cycle.
Set(s) of frequency and time resources for LP-WUS transmission.

In a second step, the BS transmits LP-WUS transmission configuration using, e.g., system information or dedicated RRC/NAS messages. In a third step, the BS initiates a RAN notification area or network paging procedure to a UE, e.g., based on higher layer messages. In a fourth step, the BS determines a low density sequence and a LP-WUS transmission occasion indicating a UE-group ID based on the UE ID. The low density sequence may be determined from a formula or from a set of sequences in a table as described above wherein the UE ID may be used instead of the cell ID to generate and/or select the sequence. The set of low density sequences should satisfy a certain criteria such as low density of 1's compared to 0's, fixed number of 1's in every OFDM symbol used for transmission of LP-WUS, and cross-correlation properties, e.g., maximum cross-correlation≤0.5×N₁ₛ. In a fifth step, the BS transmits the determined low density sequence at the determined LP-WUS transmission occasion based on the determined frequency and time resources.

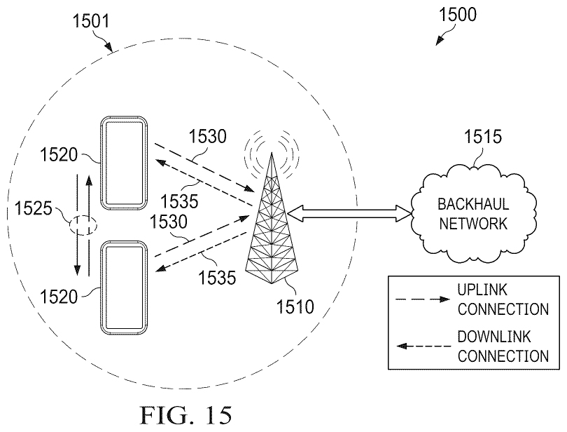

FIG. 15 illustrates an example communications system 1500. Communications system 1500 includes an access node 1510 serving user equipments (UEs) with coverage 1501, such as UEs 1520. In a first operating mode, communications to and from a UE passes through access node 1510 with a coverage area 1501. The access node 1510 is connected to a backhaul network 1515 for connecting to the internet, operations and management, and so forth. In a second operating mode, communications to and from a UE do not pass through access node 1510, however, access node 1510 typically allocates resources used by the UE to communicate when specific conditions are met. Communications between a pair of UEs 1520 can use a sidelink connection (shown as two separate one-way connections 1525). In FIG. 15, the sideline communication is occurring between two UEs operating inside of coverage area 1501. However, sidelink communications, in general, can occur when UEs 1520 are both outside coverage area 1501, both inside coverage area 1501, or one inside and the other outside coverage area 1501. Communication between a UE and access node pair occur over uni-directional communication links, where the communication links between the UE and the access node are referred to as uplinks 1530, and the communication links between the access node and UE is referred to as downlinks 1535.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

In some embodiments the system define a network for communicating data. In some such embodiments, the network comprises a base station (e.g., as at least one of the access nodes 1510) having a coverage area, a plurality of mobile devices (e.g., as at least one of the UEs 1520 and/or the like), and a backhaul network (e.g., as at least a portion of backhaul network 1515). In some embodiments, the base station establishes uplink and/or downlink connections with the mobile devices, which serve to carry data from the mobile devices to the base station and vice-versa. Data carried over the uplink/downlink connections may include data communicated between the mobile devices, as well as data communicated to/from a remote-end (not shown) by way of the backhaul network. As used herein, the term “base station” refers to any component (or collection of components) configured to provide wireless access to a network, such as an enhanced base station (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network may comprise various other wireless devices, such as relays, low power nodes, etc.

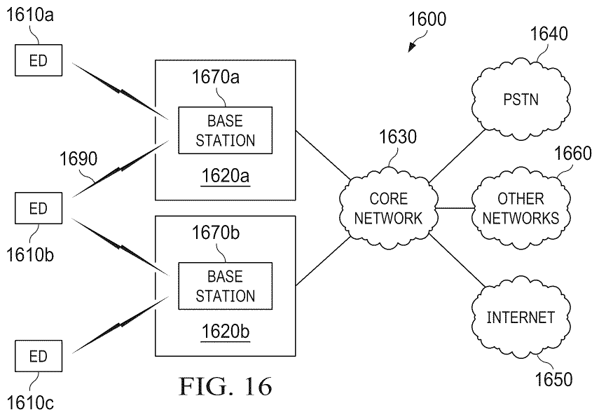

FIG. 16 illustrates an example communication system 1600. In general, the system 1600 enables multiple wireless or wired users to transmit and receive data and other content. The system 1600 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1600 includes electronic devices (ED) 1610a-1610c, radio access networks (RANs) 1620a-1620b, a core network 1630, a public switched telephone network (PSTN) 1640, the Internet 1650, and other networks 1660. While a certain number of these components or elements are shown in FIG. 16, any number of these components or elements may be included in the system 1600.

The EDs 1610a-1610c are configured to operate or communicate in the system 1600. For example, the EDs 1610a-1610c are configured to transmit or receive via wireless or wired communication channels. Each ED 1610a-1610c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1620a-1620b here include base stations 1670a-1670b, respectively. Each base station 1670a-1670b is configured to wirelessly interface with one or more of the EDs 1610a-1610c to enable access to the core network 1630, the PSTN 1640, the Internet 1650, or the other networks 1660. For example, the base stations 1670a-1670b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1610a-1610c are configured to interface and communicate with the Internet 1650 and may access the core network 1630, the PSTN 1640, or the other networks 1660.

In the embodiment shown in FIG. 16, the base station 1670a forms part of the RAN 1620a, which may include other base stations, elements, or devices. Also, the base station 1670b forms part of the RAN 1620b, which may include other base stations, elements, or devices. Each base station 1670a-1670b operates to transmit or receive wireless signals within a particular geographic region or area, sometimes referred to as a “cell.” In some embodiments, multiple-input multiple-output (MIMO) technology may be employed having multiple transceivers for each cell.

The base stations 1670a-1670b communicate with one or more of the EDs 1610a-1610c over one or more air interfaces 1690 using wireless communication links. The air interfaces 1690 may utilize any suitable radio access technology.

It is contemplated that the system 1600 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1620a-1620b are in communication with the core network 1630 to provide the EDs 1610a-1610c with voice, data, application, Voice over Internet Protocol (VoIP), or other services. Understandably, the RANs 1620a-1620b or the core network 1630 may be in direct or indirect communication with one or more other RANs (not shown). The core network 1630 may also serve as a gateway access for other networks (such as the PSTN 1640, the Internet 1650, and the other networks 1660). In addition, some or all of the EDs 1610a-1610c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1650.

Although FIG. 16 illustrates one example of a communication system, various changes may be made to FIG. 16. For example, the communication system 1600 in other embodiments could include any number of EDs, base stations, networks, or other components in any suitable configuration.

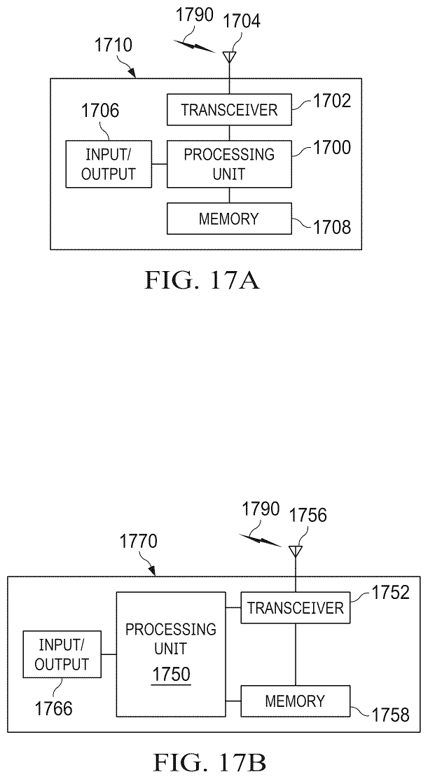

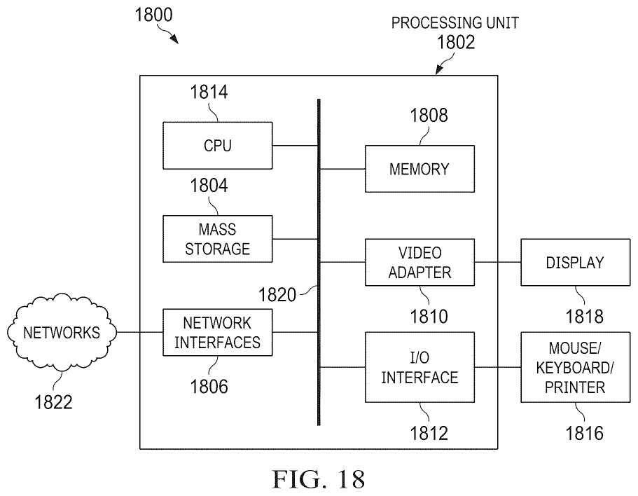

FIGS. 17A and 17B illustrate example devices that may implement the methods and teachings according to this disclosure. In particular, FIG. 17A illustrates an example ED 1710, and FIG. 17B illustrates an example base station 1770. These components could be used in the system 1600 or in any other suitable system.

As shown in FIG. 17A, the ED 1710 includes at least one processing unit 1700. The processing unit 1700 implements various processing operations of the ED 1710. For example, the processing unit 1700 could perform signal coding, data processing, power control, input/output processing, or any other functionality enabling the ED 1710 to operate in the system 1600. The processing unit 1700 also supports the methods and teachings described in more detail above. Each processing unit 1700 includes any suitable processing or computing device configured to perform one or more operations. Each processing unit 1700 could, for example, include a microprocessor, microcontroller, digital signal processor, field programmable gate array, or application specific integrated circuit.

The ED 1710 also includes at least one transceiver 1702. The transceiver 1702 is configured to modulate data or other content for transmission by at least one antenna or NIC (Network Interface Controller) 1704. The transceiver 1702 is also configured to demodulate data or other content received by the at least one antenna 1704. Each transceiver 1702 includes any suitable structure for generating signals for wireless or wired transmission or processing signals received wirelessly or by wire. Each antenna 1704 includes any suitable structure for transmitting or receiving wireless or wired signals. One or multiple transceivers 1702 could be used in the ED 1710, and one or multiple antennas 1704 could be used in the ED 1710. Although shown as a single functional unit, a transceiver 1702 could also be implemented using at least one transmitter and at least one separate receiver.

The ED 1710 further includes one or more input/output devices 1706 or interfaces (such as a wired interface to the Internet 1650). The input/output devices 1706 facilitate interaction with a user or other devices (network communications) in the network. Each input/output device 1706 includes any suitable structure for providing information to or receiving information from a user, such as a speaker, microphone, keypad, keyboard, display, or touch screen, including network interface communications.

In addition, the ED 1710 includes at least one memory 1708. The memory 1708 stores instructions and data used, generated, or collected by the ED 1710. For example, the memory 1708 could store software or firmware instructions executed by the processing unit(s) 1700 and data used to reduce or eliminate interference in incoming signals. Each memory 1708 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 17B, the base station 1770 includes at least one processing unit 1750, at least one transceiver 1752, which includes functionality for a transmitter and a receiver, one or more antennas 1756, at least one memory 1758, and one or more input/output devices or interfaces 1766. A scheduler, which would be understood by one skilled in the art, is coupled to the processing unit 1750. The scheduler could be included within or operated separately from the base station 1770. The processing unit 1750 implements various processing operations of the base station 1770, such as signal coding, data processing, power control, input/output processing, or any other functionality. The processing unit 1750 can also support the methods and teachings described in more detail above. Each processing unit 1750 includes any suitable processing or computing device configured to perform one or more operations. Each processing unit 1750 could, for example, include a microprocessor, microcontroller, digital signal processor, field programmable gate array, or application specific integrated circuit.

Each transceiver 1752 includes any suitable structure for generating signals for wireless or wired transmission to one or more EDs or other devices. Each transceiver 1752 further includes any suitable structure for processing signals received wirelessly or by wire from one or more EDs or other devices. Although shown combined as a transceiver 1752, a transmitter and a receiver could be separate components. Each antenna 1756 includes any suitable structure for transmitting or receiving wireless or wired signals. While a common antenna 1756 is shown here as being coupled to the transceiver 1752, one or more antennas 1756 could be coupled to the transceiver(s) 1752, allowing separate antennas 1756 to be coupled to the transmitter and the receiver if equipped as separate components. Each memory 1758 includes any suitable volatile or non-volatile storage and retrieval device(s). Each input/output device 1766 facilitates interaction with a user or other devices (network communications) in the network. Each input/output device 1766 includes any suitable structure for providing information to or receiving/providing information from a user, including network interface communications.

FIG. 18 is a block diagram of a computing system 1800 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1800 includes a processing unit 1802. The processing unit includes a central processing unit (CPU) 1814, memory 1808, and may further include a mass storage device 1804, a video adapter 181o, and an I/O interface 1812 connected to a bus 1820.

The bus 1820 may be one or more of any type of several bus architectures including a memory bus or memory controller, a peripheral bus, or a video bus. The CPU 1814 may comprise any type of electronic data processor. The memory 1808 may comprise any type of non-transitory system memory such as static random access memory (SRAM), dynamic random access memory (DRAM), synchronous DRAM (SDRAM), read-only memory (ROM), or a combination thereof. In an embodiment, the memory 1808 may include ROM for use at boot-up, and DRAM for program and data storage for use while executing programs.

The mass storage 1804 may comprise any type of non-transitory storage device configured to store data, programs, and other information and to make the data, programs, and other information accessible via the bus 1820. The mass storage 1804 may comprise, for example, one or more of a solid state drive, hard disk drive, a magnetic disk drive, or an optical disk drive.

The video adapter 1810 and the I/O interface 1812 provide interfaces to couple external input and output devices to the processing unit 1802. As illustrated, examples of input and output devices include a display 1818 coupled to the video adapter 1810 and a mouse, keyboard, or printer 1816 coupled to the I/O interface 1812. Other devices may be coupled to the processing unit 1802, and additional or fewer interface cards may be utilized. For example, a serial interface such as Universal Serial Bus (USB) (not shown) may be used to provide an interface for an external device.

The processing unit 1802 also includes one or more network interfaces 1806, which may comprise wired links, such as an Ethernet cable, or wireless links to access nodes or different networks. The network interfaces 1806 allow the processing unit 1802 to communicate with remote units via the networks. For example, the network interfaces 1806 may provide wireless communication via one or more transmitters/transmit antennas and one or more receivers/receive antennas. In an embodiment, the processing unit 1802 is coupled to a local-area network 1822 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

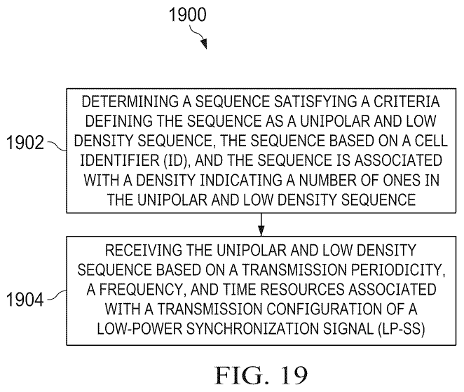

FIG. 19 depicts an example process 1900 by a wireless transmit/receive unit (WTRU) in accordance with embodiments of the present disclosure. The WTRU may include computer-readable code or instructions executing on one or more processors of the WTRU. Coding of the software for carrying out or performing the process 1900 is well within the scope of a person of ordinary skill in the art having regard to the present disclosure. The process 1900 may include additional or fewer operations than those shown and described and may be carried out or performed in a different order. Computer-readable code or instructions of the software executable by the one or more processors may be stored on a non-transitory computer-readable medium, such as for example, the memory of the WTRU. In some embodiments, the process 1900 may be performed by one or more of units or modules (e.g., an integrated circuit) of the WRTU, such as field programmable gate arrays (FPGAs) or application-specific integrated circuits (ASICs).

The process 1900 includes a step 1902 of determining a sequence satisfying a criteria defining the sequence as a unipolar and low density sequence. In some embodiments, the sequence is based on a cell identifier (ID). Additionally or alternatively, in some embodiments, the sequence is associated with a density indicating a number of ones in the unipolar and low density sequence.

The process 1900 further includes a step 1904 of receiving the unipolar and low density sequence. In some embodiments, the unipolar and low density sequence is received based on a transmission periodicity, a frequency, and time resources associated with a transmission configuration of a low-power synchronization signal (LP-SS).

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a transmission configuration determining unit/module, a unipolar and low density sequence determining unit/module, and/or a sequence transmitting unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method, comprising:
determining, by a wireless transmit/receive unit (WTRU), a sequence, the sequence being a unipolar and low density sequence comprising a number of ones in the sequence, wherein the number of ones in the sequence defines a density of the sequence, wherein the density of the sequence is low density by being less dense than a balanced density of 1 by at least two bits; and
receiving, by the WTRU, the unipolar and low density sequence based on at least one of a transmission periodicity or time resources, and a frequency, associated with a transmission configuration of at least a portion of a signal, the portion of the signal comprising at least a low-power synchronization signal (LP-SS) or a preamble portion of a low-power wake up signal (LP-WUS).

2. The method of claim 1, wherein determining the sequence comprises:
selecting the unipolar and low density sequence from a set of two or more pre-configured low density sequences.

3. The method of claim 2, wherein determining the sequence comprises:
receiving, by the WTRU from a base station, index information indicating an index of the unipolar and low density sequence in the set of two or more pre-configured low density sequences.

4. The method of claim 2, wherein, at any offset other than 0, at least one balanced auto correlation value of the set of two or more pre-configured low density sequences is less than a balanced auto correlation threshold that is less than at least one peak value of the at least one balanced auto correlation value.

5. The method of claim 4, wherein the balanced auto correlation threshold is smaller or equal to 0.3.

6. The method of claim 2, wherein at least one balanced cross correlation of the set of two or more pre-configured low density sequences is less than a threshold that is less than at least one peak value of at least one balanced auto correlation value of the set of two or more pre-configured low density sequences.

7. The method of claim 6, wherein the balanced cross correlation threshold is smaller or equal to 0.3.

8. The method of claim 1, wherein the transmission configuration of the LP-SS is transmitted to one or more UEs using any of a system information block (SIB) or a dedicated RRC message.

9. The method of claim 1, wherein the sequence is determined based on a cell identifier (ID).

10. The method of claim 9, wherein the unipolar and low density sequence is determined based on a part defined as
$$( {N}_{ID}^{( 2 )} = {N}_{ID}^{c e l l} mod 3 )$$
of the cell ID defined as
$$( {N}_{ID}^{c e l l} = 3 {N}_{ID}^{( 1 )} + {N}_{ID}^{( 2 )} ) .$$

11. The method of claim 9, wherein the unipolar and low density sequence is determined based on a part defined as
$$( {N}_{ID}^{( 3 )} = {N}_{ID}^{c e l l} mod {m}_{0} )$$
of the cell ID defined as
$$( {N}_{ID}^{c e l l} ) ,$$
wherein m₀ comprises a number of low density sequences supported by a system.

12. The method of claim 1, wherein the unipolar and low density sequence comprises a unipolar sequence of N₀ₛ 0 bits and N₁ₛ 1 bits, and wherein the density (η) of the unipolar and low density sequence is defined as
$$η = \frac{2 {N}_{1 s}}{{N}_{1 s} + {N}_{0 s}} .$$

13. The method of claim 1, wherein the density of the unipolar and low density sequence is less than or equal to any of 9/10, ¾, ½, or ¼.

14. The method of claim 1, further comprising:
receiving a set of sequences having a number of sequences indicated based on a upper bound of the density.

15. The method of claim 1, wherein the unipolar and low density sequence has an equal number of 1 bits in each OFDM symbol duration within an LP-SS transmission duration.

16. The method of claim 1, wherein the receiving the unipolar and low density sequence comprises:
receiving a preamble and a signal body, the preamble comprising the unipolar and low density sequence.

17. The method of claim 1, wherein the receiving the unipolar and low density sequence comprises:
receiving the LP-SS comprising the unipolar and low density sequence.

18. The method of claim 1, wherein the receiving the unipolar and low density sequence comprises:
receiving, by the WTRU, the unipolar and low density sequence in a cellular network.

19. A method, comprising:
determining, by a base station, a sequence, the sequence being a unipolar and low density sequence comprising a number of ones in the sequence, wherein the number of ones in the sequence defines a density of the sequence, wherein the density of the sequence is less dense than a balanced density of 1 by at least two bits; and
transmitting, by the base station to a wireless transmit/receive unit (WTRU), the unipolar and low density sequence.

20. A wireless transmit/receive unit (WTRU), comprising:
at least one processor; and
a non-transitory computer readable storage medium storing programming, the programming including instructions that, when executed by the at least one processor, cause the WTRU to perform operations:
determining a sequence, the sequence being a unipolar and low density sequence comprising a number of ones in the sequence, wherein the number of ones in the sequence defines a density of the sequence, wherein the density of the sequence is low density by being less dense than a balanced density of 1 by at least two bits; and
receiving the unipolar and low density sequence based on at least one of a transmission periodicity or time resources, and a frequency, associated with a transmission configuration of at least a portion of a signal, the portion of the signal comprising at least a low-power synchronization signal (LP-SS) or a preamble portion of a low-power wake up signal (LP-WUS).
